(19) United States
(12) Patent Application Publication
(10) Pub. No.: US 2002/0111826 A1
(43) Pub. Date: Aug. 15, 2002

(54) Method of administering a health plan

(76) Inventors: Jane I. Potter, Ellisville, MO (US); Herbert B. Schneiderman, Chesterfield, MO (US)

Correspondence Address: Bryan K. Wheelock, Harness, Dickey & Pierce, P.L.C., Suite 400, 7700 Bonhomme, St. Louis, MO, 63105, US

(21) Appl. No.: 09/922,297

(22) Filed: Aug. 3, 2001

Related U.S. Application Data
(60) Provisional application No. 60/251,923, filed on Dec. 7, 2000.

(51) Int. Cl. G06F 17/60

(52) U.S. Cl. 705/2

(57) ABSTRACT

A method of administering a health plan include compensating physicians to manage the cost and quality of health services provided to members of a health plan served by a plurality of physician groups. More specifically, the method includes developing a budgeted cost per episode of patient care for a program period for each of several physician groups based at least in part on the historic actual performance of each group; compiling data on actual cost per episode of patient care during the program period; comparing the group's actual cost per episode of patient care during the program period with the group's budgeted cost per episode of patient care for the program period, adjusted for changes in the severity of illness of the patients treated; sharing a portion of the savings resulting from a reduction in actual cost per episode of patient care with the group, the portion depending in part upon the group's cost performance in relation to the performance of other physicians in the applicable medical specialty, and in part on the group's performance on a quality indicator and/or patient satisfaction in relation to the performance of other physicians in the applicable medical specialty.

### BACKGROUND OF THE INVENTION

This invention relates to a method of administering health plans, and in particular to methods of compensating groups of physicians for providing medical services to patients belonging to a health plan.

There are various methods of administering health plans to take into account the goals of providing quality health services with high patient satisfaction while controlling costs. One type of health plan structure is a health maintenance organization (HMO) which offers prepaid, comprehensive health coverage for both hospital and physician services. An HMO contracts with health services providers, e.g., physicians, hospitals, and other health professionals, and members are required to use participating providers for all health services if they want the services to be covered by the plan. Members are enrolled for a specified period of time. Model types include staff, group practice, network and IPA. A common way of compensating primary care physicians (PCPs) in an HMO plan is based on capitation—a method of payment in which the provider is paid a fixed amount for each member who selects the physician as their PCP no matter what the actual number or nature of services delivered by the PCP. Another type of health plan structure is the preferred provider organization (PPO) which is a combination of hospitals and physicians that agrees to render particular services to a group of people under contract with an insurer. The services are commonly furnished at discounted rates and the insured population may incur out-of-pocket expenses for covered services received inside or outside of the PPO. The physicians are typically compensated a discounted fee based on services actually provided.

The problem with existing health plan structures has been to provide appropriate incentives for physician decision makers in the health services process to control costs without sacrificing the quality of health care or patient satisfaction. The incentives may apply to the whole health care process, and not merely to individual services.

### SUMMARY OF THE INVENTION

The method of the present invention recognizes that physicians are the health services experts and represent the ultimate key to reducing a health plan's total medical costs. Physicians are in the best position to manage health costs, and can manage health costs more effectively, and work most efficiently on behalf of patient's health needs in a group practice environment. The method also recognizes that physicians provided with accurate utilization data on a timely basis will make better decisions.

Generally, in accordance with the principles of the present invention, contracts are made between the health plan and groups of physicians to provide health services to members of the health plan. The method comprises a way of compensating physician groups that provides appropriate incentives to control costs, while maintaining quality of care and/or patient satisfaction. Groups of physicians are entitled to share in cost savings compared to the group's past experience which is represented in the form of an annual budget. Eligibility for sharing in cost savings is dependent upon the group's first achieving certain quality and patient satisfaction goals, and preferably the size of the share depends upon the level of quality and patient satisfaction achieved by the group. The size of the share preferably also depends upon the relative cost performance of the group compared to other physicians in the applicable medical specialty in the network.

Generally, the method of compensating physician groups that are part of a network providing health services to patients comprises determining an unadjusted final budget based upon the group's historical cost experience; determining goals for medical specialty specific quality indicators for the group is based upon the applicable medical specialty network's prior scores for those indicators; determining goals for patient satisfaction indicators for the group based upon a network's (or a portion of a network's) prior scores for those indicators; providing data to the group and the individual physicians in the group, regarding utilization and quality results; finalizing the group's unadjusted final budget by case mix adjusting to the group's actual case mix and trending the budget for inflation; awarding additional compensation to the group if there is a positive variance between the finalized budget and the actual cost. Additional compensation is preferably based on the group's performance relative to other applicable medical specialty physicians and is preferably dependant upon achieving certain measures of quality and patient satisfaction.

### BRIEF DESCRIPTION OF THE DRAWINGS

FIG. 1 is a sample Budget vs. Actual Interim Report, comparing the group's actual TACClessRx to the casemix adjusted budget and broken out in the major categories of, Professional, Facility, Other, and Outpatient Drug;

FIG. 2 is a sample Network vs. Actual Interim Report comparing the group's actual TACClessRx to the casemix adjusted applicable medical specialty network, and broken out in the major categories of Professional, Facility, Other and Outpatient Drug;

FIG. 3 is a sample Group PTE Profile with Network Comparison, comparing PTE Equivalents, Case Mix, and TACClessRx for a group and the network;

FIG. 4 is a sample Physician PTE Profile showing PTE description, PTE equivalents, Case Mix, and TACClessRx including Professional, Facility, Drug and other costs;

FIG. 5 is a sample Physician PTE by Cost Categories, showing Professional Services charges, Facility Charges, and other charges by Physician, Group, Variance, Specialty Network, and Variance;

FIG. 6 is a sample PTE Detail Utilization—Inpatient report;

FIG. 7 is a sample PTE Detail Utilization—Outpatient report;

FIG. 8 is a sample Physician Quality Indicator Member Detail report;

FIG. 9 is a sample Annual Reconciliation Report;

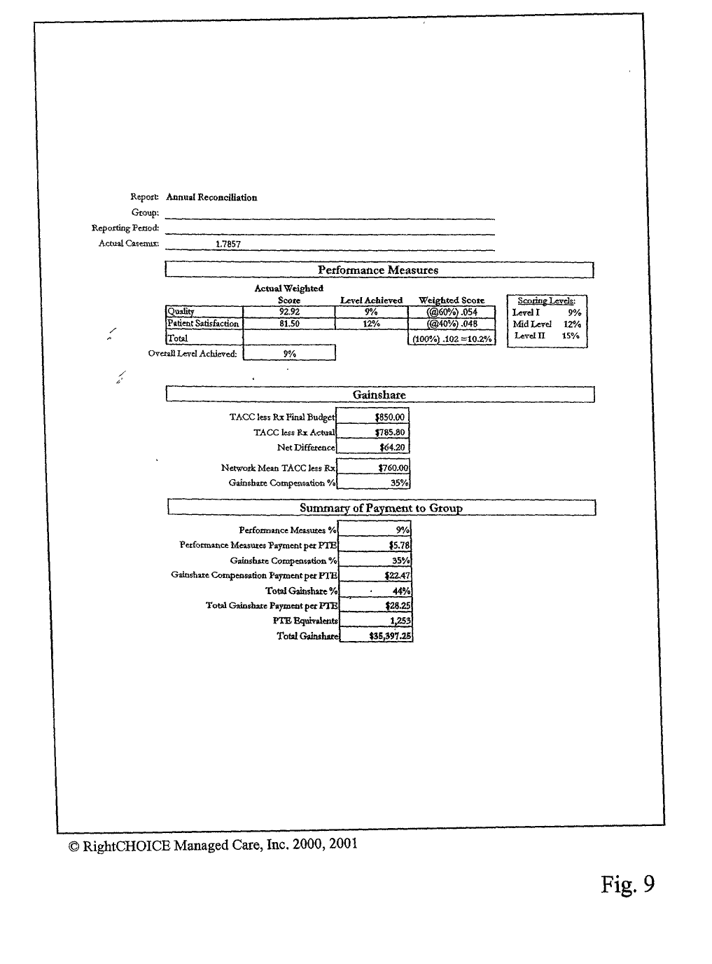

FIG. 10 is a sample Group Quality Indicator Summary report;

FIG. 11 is a sample Patient Satisfaction Survey Results—Group report;

FIG. 12 is a sample Patient Satisfaction Survey Results—Physician report;

FIG. 13 is a sample Patient Satisfaction Survey Age/Sex Breakdown—Group report;

FIG. 14 is a sample Patient Satisfaction Survey Age/Sex Breakdown—Physician;

FIG. 15 is a sample Annual Performance Measures report;

FIG. 16 is a sample Subsequent Year Budget Detail report;

FIG. 17 is a sample Subsequent Year Budget report;

FIG. 18 is a sample Medical Cost Trend Comparison report;

FIG. 19 is a sample Program Specialist Model Aggregate Medical Cost Trend Compared to non-Program Network report;

FIG. 20 is a sample Full Network Detail Report by Physician;

FIG. 21 is a sample Non-Program Specialty Network Average Report by Region and Specialty;

FIG. 22 is a sample Program Specialty Network Average Report by Region and Specialty;

FIG. 23 is a sample Full Specialty Network Average Report by Region and Specialty

FIG. 24 is a sample Non-Program Network Summary Report by Specialty;

FIG. 25 is a sample Program Network Summary Report by Specialty; and

FIG. 26 is a sample Full Network Summary Report by Specialty;

FIG. 27 is a sample Budget-Final Unadjusted report;

FIG. 28 is a sample Group PTE Profile report;

FIG. 29 is a sample Physician Ranking report;

FIG. 30 is a sample Physician PTE Summary report;

FIG. 31 is a sample Program Specialist Model Reporting of Fee for Service Payments by Physician Report; and

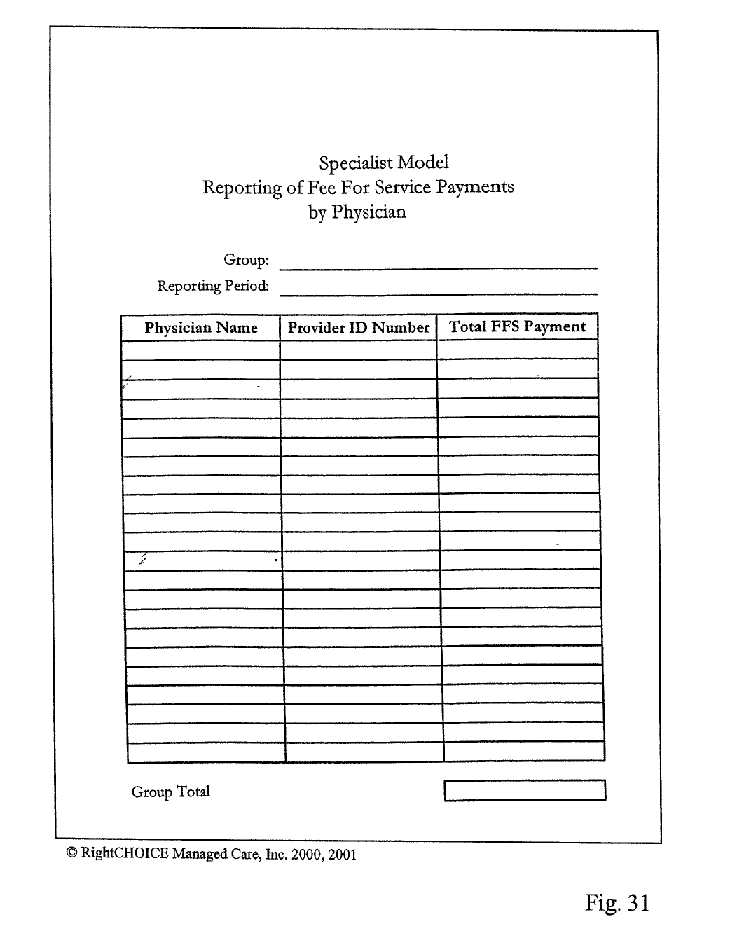

FIG. 32 is an illustration of a patient satisfaction survey of the type that may be employed in conjunction with the methods of the present invention.

### DETAILED DESCRIPTION OF THE PREFERRED EMBODIMENT

Recognizing that the physician is often in the best position to balance the appropriateness of medical care with the cost of providing that care, and that physicians often make better decisions in this regard when they are acting as part of a group, the method of this invention provides a way of managing the provision of health care to members of a health plan that provides incentives to groups of physicians for achieving cost savings, but only if certain quality and patient satisfaction levels are first achieved.

According to the principles of this invention, a budget is prepared for a physician group based upon the physician group's actual past experience. The budget is comprised of patient treatment episodes (PTE'S), which include all of the downstream medical care costs incurred in diagnosing and/or treating a particular disease or medical condition (or at least the covered costs for the disease or condition), during a specific episode (time period) of care.

The PTE preferably includes all services and treatments performed until the illness or condition is abated. There are two types of PTE's: chronic PTE's, which include all the services and treatments for a chronic condition that does not abate, and acute PTE's which include all services and treatments for an illness or medical condition that ends or abates. A PTE includes services that are not necessarily typical, but address the same condition as the core procedure or complications of the core procedure. It may include radiology and diagnostic services that deal with the same body system or medical condition as the core procedure, pathology and lab services that are typically performed in relation to the core procedure or underlying condition, and evaluation and management services.

Each PTE is initiated by a claim for treatment related to a particular disease or condition, and continues until there is a break or gap in claims related to that disease or condition equal to a predetermined window period. The window period varies from PTE to PTE depending upon the disease or condition to which the PTE relates. The diseases and conditions that start a PTE and the window period for PTE's relating to the diseases or conditions can be developed by the health plan, or one of many health care software companies. Data from claims is processed and collected in one or more PTE's for each patient based upon the disease or condition that caused the patient to seek treatment. One organization that processes claims data into PTE's is Express Scripts, Inc., Data Integration Division (ESDID) a wholly owned division of Express Scripts, Inc., of St. Louis, Miss. ESDID has identified more than 1100 diagnostic clusters based upon the International Classification of Disease (9^{th} Edition), commonly referred to as ICD-9, developed in conjunction with the World Health Organization, and well known in the health care industry and incorporated herein by reference. Other well known schemes for organizing diseases and conditions in diagnostic clusters include Schneeweiss and Rosenblatt's, Diagnostic Clusters (1983), J. Gonella, Disease Staging (1986), and Rand's Longitudinal Episode Definitions (1985), all of which are incorporated herein by reference. Still another scheme is American Medical Association's CPT-4, also incorporated herein by reference. These schemes could be used directly or adapted for use in identifying and managing PTE's, by grouping the codes into meaningful groups or diagnostic clusters, based upon clinical homogeneity with respect to generating a similar clinical response from physicians, reducing the effect of idiosyncratic diagnosis coding patterns. PTE's generally allow for the analysis of medical services on a complete course of treatment basis, rather than on an incident by incident basis.

As described above, each PTE has a window period associated with it, which depends upon the disease or condition to which the PTE relates. This window period is based upon the maximum number of days between contact with a health services provider for which follow-up care is still reasonable. This provides a clinically valid approach because the patient's episode duration relates directly to their process of care. This allows condition-specific practice patterns to be developed for each physician. Each diagnostic cluster has its own unique window period. When there is a gap or break in claims for medical services that exceeds the window period, the PTE ends, and future claims, even for the exact same disease or condition, mark the start of a new PTE. It is possible that a single patient could simultaneously have multiple PTE's. As described above particularly with respect to chronic PTE's, it is further possible that PTE do not end but rather continue from year to year.

The PTE is associated with the physician and thus the physician group that is the source for the largest amount of the professional claims. Thus when several physicians are involved in treating the patient for a particular disease or condition, the PTE related to that disease or condition is associated with the physician responsible for the most professional charges.

The program is preferably implemented with ten target specialties: Internal Medicine/Family Practice, Pediatrics, Obstetrics/Gynecology, Cardiology, Orthopedics, General Surgery, Gastroenterology, Urology, Otolaryngology, Ophthalmology, although fewer, more, or different specialties could be used.

According to a program implementing the method of this invention, a budgeted total average covered charge less drug (TACClessRx) is developed for each participating physician group preferably based upon the past experience of the physicians in the group. While the program is open to any group of physicians, to qualify for the performance based additional compensation that is a significant feature of this program, the group should average at least a minimum level of past experience. Thus in the preferred embodiment, the average number of PTE's per physician in a group should meet or exceed a predetermined threshold before the group can participate in the performance based additional compensation feature of the program. Furthermore, the threshold may vary from group to group, depending upon the particular medical specialty of the group. Table 1 shows a minimum average level of experience for various specialties that might be used to implement the methods of this invention. In a network using the minimums set forth in Table 1, the average level of experience of the physicians in a group must exceed the minimum in the table, or the group cannot participate in the performance based additional compensation.

TABLE 1
Minimum Experience to Participate

| | Average Number of |
|---|---|
| Specialty | PTEs Per Physician |
| OB/GYN | 5 |
| Pediatrics | 2 |
| Orthopedics | 4 |
| General Surgery | 1 |
| Cardiology | 1 |
| Urology | 8 |
| Ophthalmology | 3 |
| Gastroenterology | 5 |
| Otolaryngology | 6 |
| Family/General | 2 |
| Practice | |
| Internal | 2 |
| Medicine | |

### EXAMPLE 1

A OB/GYN group of five physicians has the following experience: Physician A—4 PTE's, Physician B—0 PTE's, Physician C—10 PTE's, Physician D—5 PTE's and Physician E—6 PTE's. The average level of experience is 25 PTE's/5 or 5 PTE's per physician. This group equals the minimum average experience level, and can participate in the performance based compensation feature of the program. As explained in more detail below, according to Table 2, 25% of this group's experience would be used and 75% of the applicable network experience would be used. Even if the group could not participate in the performance-based additional compensation feature, program participation is valuable to the group because it provides various reporting information about the group and its performance relative to other groups.

The budget for the group is determined based at least in part on the group's historic (e.g., last twelve month) performance. Preferably, there is a weighted application of the group's historic performance and the network's historic performance over the same period. The inventors have determined that the weighting factor for the group's historic performance preferably depends upon the particular medical specialty of the group. Table 2 is an example of a possible scheme for weighting a group's historic performance based upon the average number of PTE's per physician prior to joining the program:

TABLE 2
Credibility Factor to Apply to Specialist Group's Own Experience

| | | | | | | | | 90%- |
|---|---|---|---|---|---|---|---|---|
| | 25% | 35% | 45% | 55% | 65% | 75% | 85% | 100% |
| OB/GYN | 5 | 9 | 12 | 18 | 27 | 44 | 85 | 137 |
| Pediatrics | 2 | 3 | 5 | 7 | 10 | 17 | 32 | 54 |
| Orthopedics | 4 | 6 | 8 | 13 | 19 | 30 | 58 | 93 |
| General | I | 2 | 3 | 4 | 6 | 10 | 17 | 28 |
| Surgery | | | | | | | | |
| Cardiology | 1 | 2 | 3 | 4 | 6 | 10 | 17 | 28 |
| Urology | 8 | 13 | 20 | 30 | 46 | 73 | 135 | 181 |
| Ophthalmology | 3 | 4 | 6 | 10 | 15 | 24 | 45 | 72 |
| Gastroenter- | 5 | 6 | 8 | 12 | 27 | 43 | 78 | 122 |
| ology | | | | | | | | |
| Otolaryngology | 6 | 9 | 13 | 20 | 30 | 50 | 93 | 146 |
| Family Practice | 2 | 3 | 5 | 7 | 10 | 18 | 32 | 54 |
| Internal | 2 | 3 | 5 | 7 | 10 | 18 | 32 | 54 |
| Medicine | | | | | | | | |

Example 2 illustrates the application of the credibility factor to determining the first year's budget.

### EXAMPLE 2

An OB/GYN group has an average of 21 PTE's/physician in the year prior to joining the program. In the OB/GYN category (row 1 in Table2), 21 is closest to “18”, which corresponds to the 55% credibility factor. This means that the group's own experience is given 55% weight, and the applicable medical specialty network's overall experience for that specialty is given 45% weight (100%-55%).

The number of physicians that receive 100% credibility for their historical experience is a matter of statistical analysis. For most specialties, the percentage of physicians receiving 100% credibility for their past experience should be less than 50%, and this can be adjusted by adjusting the average number of PTE's required for each credibility level. Table 3 illustrates one possible arrangement for the percentage of physicians receiving 100% credibility of past experience in the various specialties in Table 2:

TABLE 3
% of Physician Groups
Receiving 100% Credibility

| | |
|---|---|
| OB/GYN | 20% |
| Pediatrics | 55% |
| Orthopedics | 20% |
| General Surgery | 30% |
| Cardiology | 35% |
| Urology | 1% |
| Ophthalmology | 25% |
| Gastroenterology | 10% |
| Otolaryngology | 20% |
| Family Practice | 38% |
| Internal | 38% |
| Medicine | |

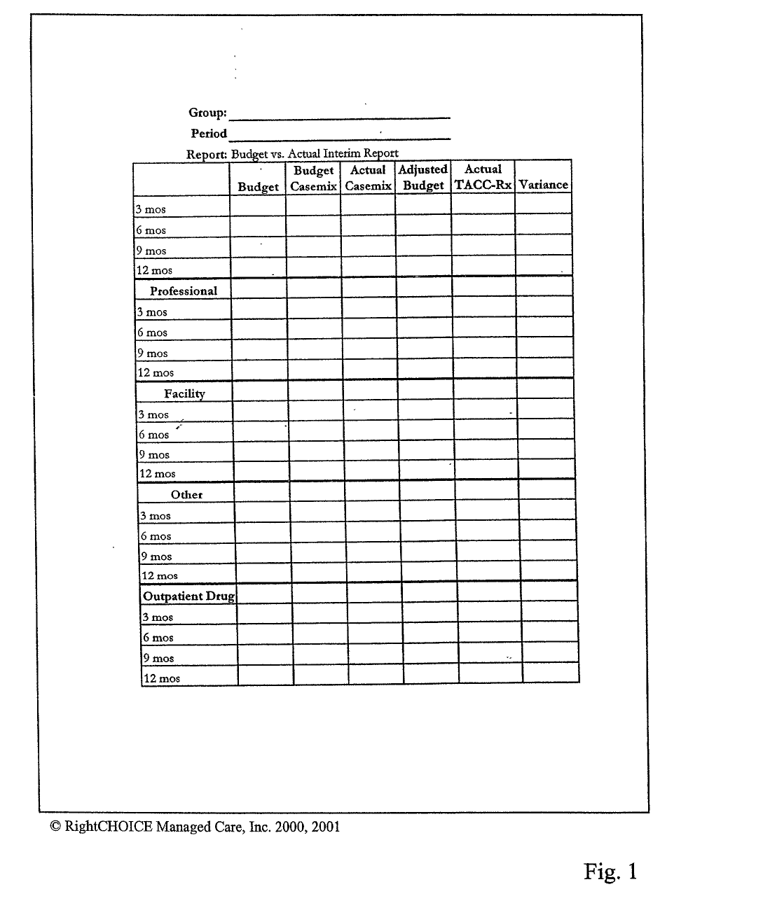

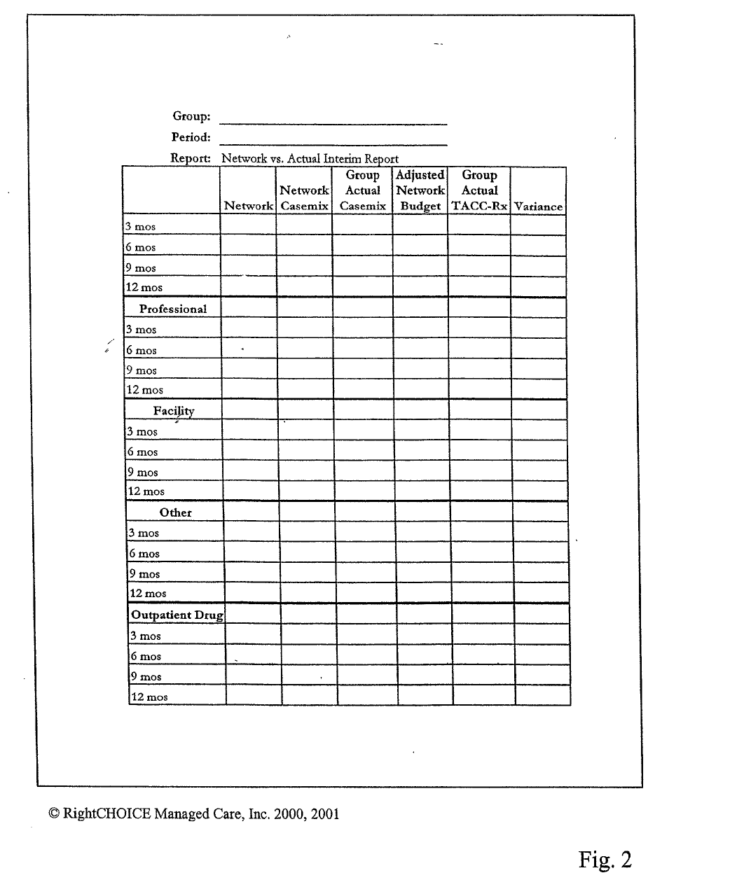

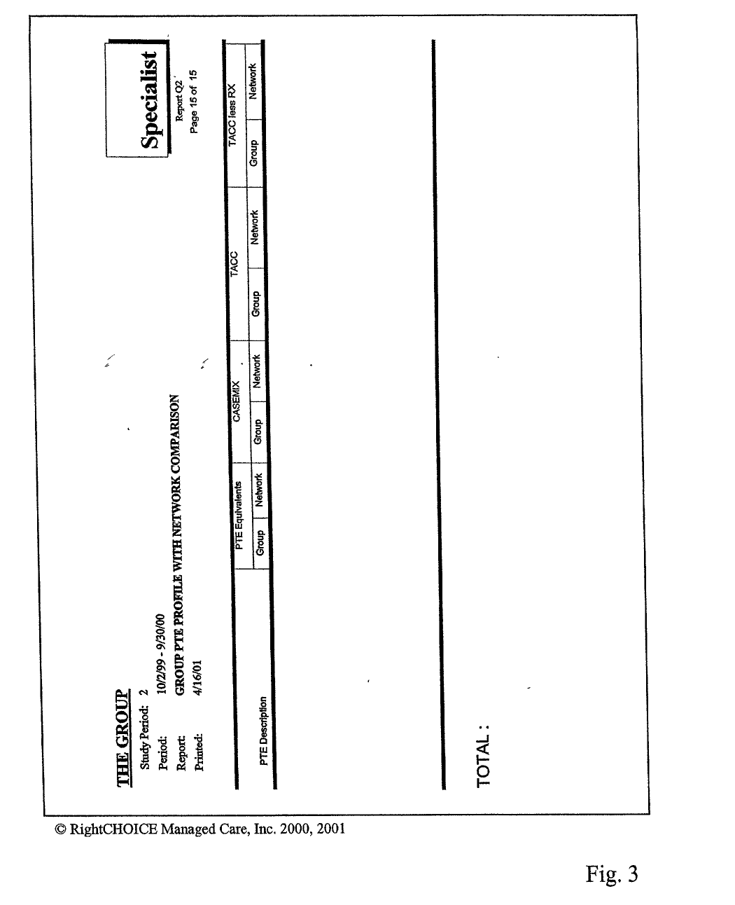

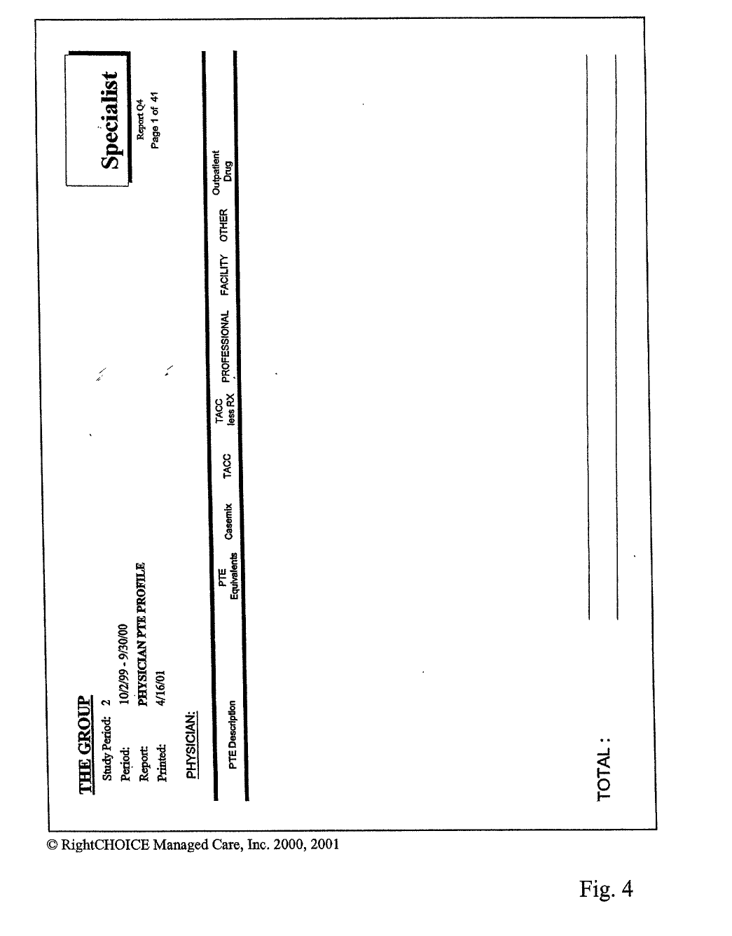

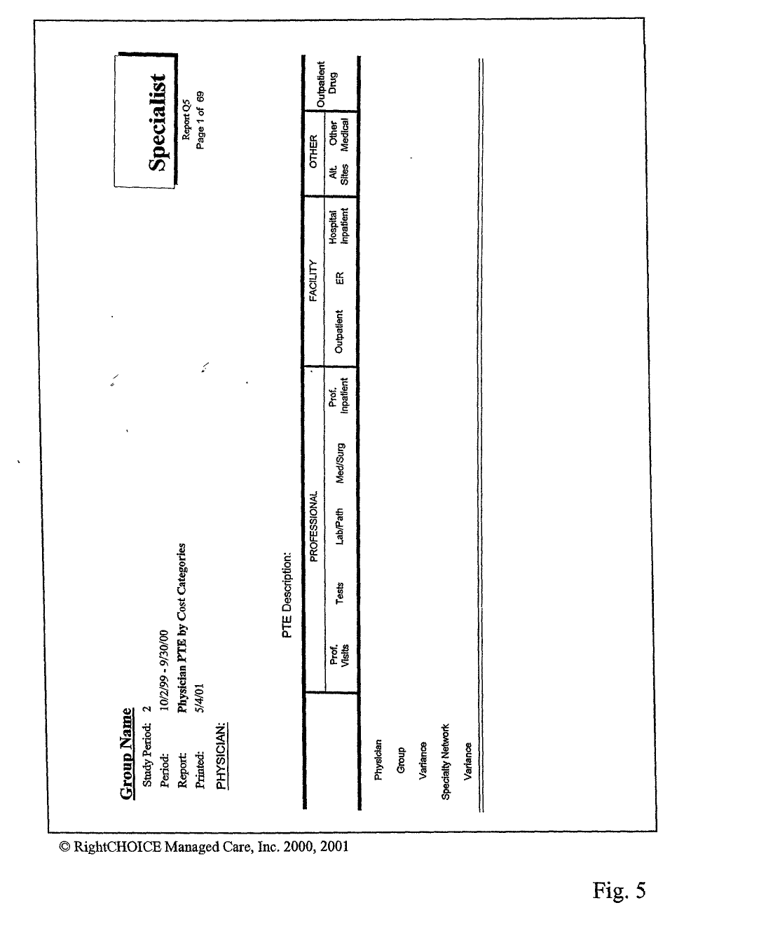

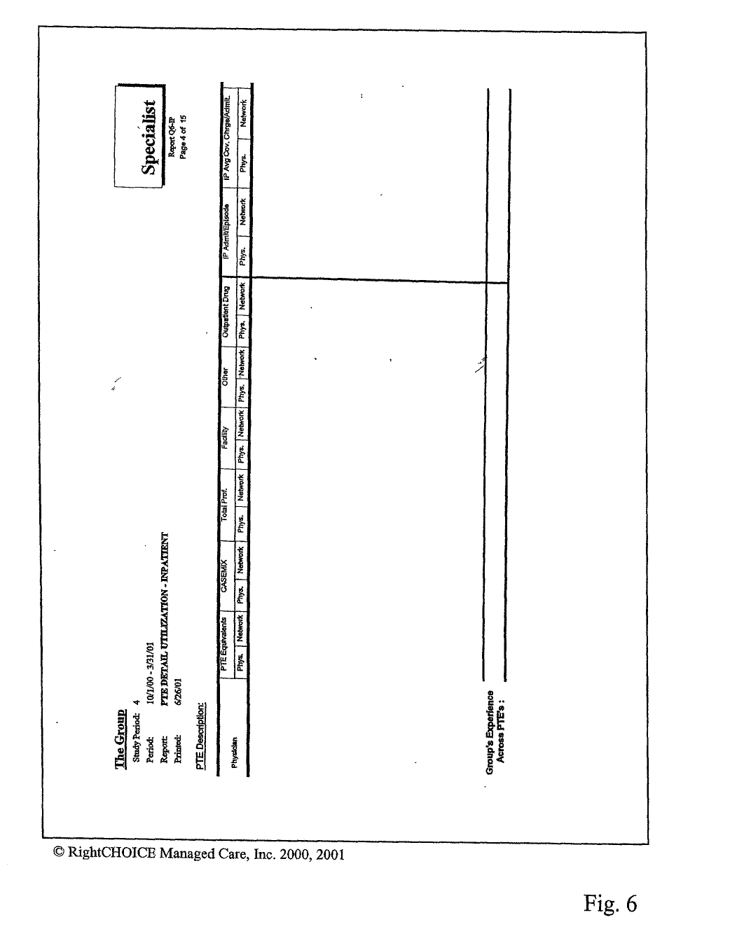

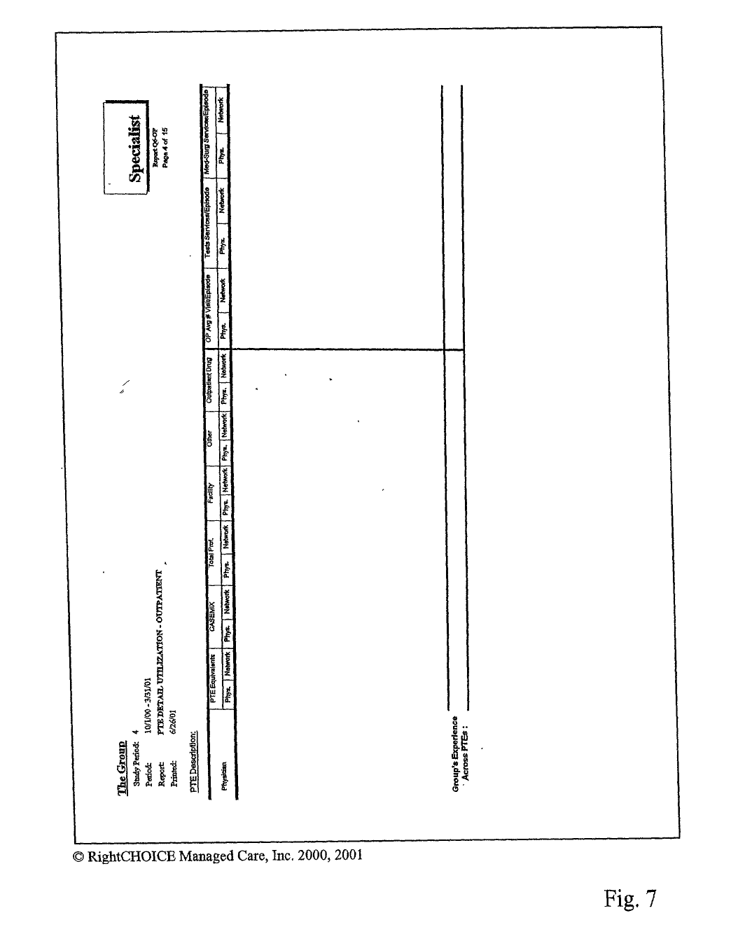

Once the group's budget is determined, the physicians in the group perform health services during the year. Statistics regarding the number of PTE's, the TACClessRx of the group, and of other groups in the network are collected and distributed. These reports provide valuable utilization and measure performance information and may enable the physicians in the groups to better manage their patient's health needs. FIG. 1 is a sample Budget vs. Actual Interim Report showing TACClessRx, Professional, Facility, Other, and Outpatient Drug. FIG. 2 is a sample Network vs. Actual Interim Report, showing TACClessRx, Professional Facility, Other, and Outpatient Drug. FIG. 3 is a sample Group PTE Profile with Network Comparison, comparing PTE Equivalents, Case Mix, and TACClessRx for a group and the network. FIG. 4 is a sample Physician PTE Profile showing PTE description, PTE equivalents, Case Mix, and TACClessRx including Total, Professional, Facility, Drug and other costs. FIG. 5 is a sample Physician PTE by Cost Categories, showing Professional Services charges, Facility Charges, and other charges by Physician, Group, Variance, Specialty Network, and Variance. FIG. 6 is a sample PTE Detail Utilization-Inpatient Report. FIG. 7 is a sample PTE Detail Utilization-Outpatient Report.

Claims for health services are paid by the health plan as they normally would be.

As discussed above, a group must meet minimum quality and patient satisfaction goals to be eligible for additional compensation. The initial criteria shaping the selection of quality and patient satisfaction measures should draw on well-known surveys and scoring methodologies, and the thresholds should be reasonable. There are a variety of third-party organization that have or may in the future publish objective quality indicators, for example Health Employer Data Information Set (HEDIS), American Accreditation Health Care Commission Utilization Review Accreditation Committee (URAC) or National Committee for Quality Assurance (NCQA). These have the advantage of having nationally validated scoring algorithms available. Alternatively, quality indicators can be developed by the health plan implementing the program, preferably in consultation with the participating physicians. One type of quality indicators that can be established is percentages of patients that receive or do not receive particular treatments.

Further specificity—there are PTE based and frequency based indicators. PTE based indicators are indicators directly associated with a diagnosis. Frequency based indicators pertain to the rate of specific procedures or preventative screening.

These types of indicators are shown in Table 4:

TABLE 4
Quality Indicators by Specialty

| | Specialty | | | | | | | |
|---|---|---|---|---|---|---|---|---|
| | Network | Standard | | | | | | |
| | Actual | Deviation | Low | High | 0% | 9% | 12% | 15% |
| Cardiology | | | | | | | | |
| Congestive heart failure with | 70% | 7.84 | 62.20% | 77.90% | <62% | 62%-78% | 78% <86% | 86% |
| ACE/ARBs | | | | | | | | |
| Congestive heart failure with Beta | 51.10% | 8.56% | 42.50% | 59.70% | <43% | 43%-60% | 60% <69% | 69% |
| Blocker | | | | | | | | |
| CABG | 2.20% | 0.66% | 1.50% | 2.80% | >3% | 1.5%-3% | 1.5% >0.8% | 0.8% |
| Internal Medicine | | | | | | | | |
| Diabetes with ACE/ARB | 32.50% | 3.38% | 29.10% | 35.80% | <29% | 29%-36% | 36% <39% | 39% |
| Ischemic heart disease with beta | 44.70% | 3.91% | 40.80% | 48.60% | <41% | 41%-49% | 49% <53% | 53% |
| blockers | | | | | | | | |
| Congestive | 73.70% | 8.15% | 65.60% | 81.90% | <66% | 66%-82% | 82% <90% | 90% |
| heart failure | | | | | | | | |
| with ACE | | | | | | | | |
| Pediatrics | | | | | | | | |
| First line Antibiotics | 67.40% | 1.05% | 66.30% | 68.40% | <66% | 66%-68% | 68% <69% | 69% |
| DTP immunization | 88.90% | 2.24% | 86.70% | 91.20% | <87% | 87%-91% | 91% <93% | 93% |
| Orthopedics | | | | | | | | |
| Laminectomy | 1.40% | .28% | 1.10% | 1.70% | >2% | 1%-2% | <1% >0.8% | 0.8% |
| Knee Arthroscopy | 6.20% | 0.57% | 5.70% | 6.80% | >7% | 6%-7% | <6% >5% | 5% |
| Carpal Tunnel | 0.90% | 0.25% | 0.70% | 1.10% | >1% | 0.7%-1% | <0.7% >0.5% | 0.5% |
| Shoulder Surgery | 2.50% | 0.37% | 2.20% | 2.90% | >3% | 2%-3% | <2% >1.8% | 1.8% |
| OB/GYN | | | | | | | | |
| Hysterectomy | 2.60% | 0.24% | 2.30% | 2.80% | >3% | 2%-3% | <2% >1.8% | 1.8% |
| Breast Cancer Screening | 70.40% | 1% | 69.40% | 71.40% | <69% | 69%-71% | 71% <72% | 72% |
| Cervical Cancer Screening | 76.80% | 0.79% | 43% | 77.60% | <76% | 76%-78% | 78% <72% | 79% |
| HRT | 44.20% | 1.30% | 42.90% | 45.50% | <43% | 43%-46% | 46% <47% | 47% |
| General Surgery | | | | | | | | |
| Cholecystitis with lap | 83.20% | 3.93% | 79.30% | 87.1 | <79% | 79%-87% | 87% <91% | 91% |
| Cholecystectomy | | | | | | | | |
| Needle localization for breast biopsy | 23.40% | 2.54% | 20.90% | 25.9 | <21% | 21%-26% | 26% <27% | 27% |
| ENT | | | | | | | | |
| Myringotomy | 23.90% | 2.46% | 21.40% | 26.30% | >26% | 21%-26% | 21% >19% | 19% |
| Tonsillectomy | 9.80% | 1.71% | 8.10% | 11.50% | >12% | 8%-12% | <8% >6% | 6% |
| Endoscopic sinus surgery | 3.70% | 0.64% | 3.10% | 4.40% | >4% | 3%-4% | <3%->2% | 2% |
| Urology | | | | | | | | |
| Prostatectomy | 3.90% | 1.18% | 2.70% | 5.10% | >5% | 3%-5% | <3% >1.5% | 1.5% |
| Prostatic hyperplasia with prostate surg | 3.10% | 1.74% | 1.30% | 4.80% | >5% | 1%-5% | <1% >0.8% | 0.8% |
| GI | | | | | | | | |
| PUD with endoscopy | 71.30% | 9.53% | 61.80% | 80.90% | >81% | 62%-81% | 62% >52% | 52% |
| Patients with endoscopy | 21.10% | 1.73% | 19.40% | 22.80% | >23% | 19%-23% | 19% >18% | 18% |
| Opthamology | | | | | | | | |
| Cataract surgery | 3.30% | 0.63% | 2.70% | 3.90% | >4% | 3%-4% | <3% >2% | 2% |

Of course the quality indicators and corresponding percentages set forth in Table 4 are representative only, and additional and/or different indicators and percentages could be used.

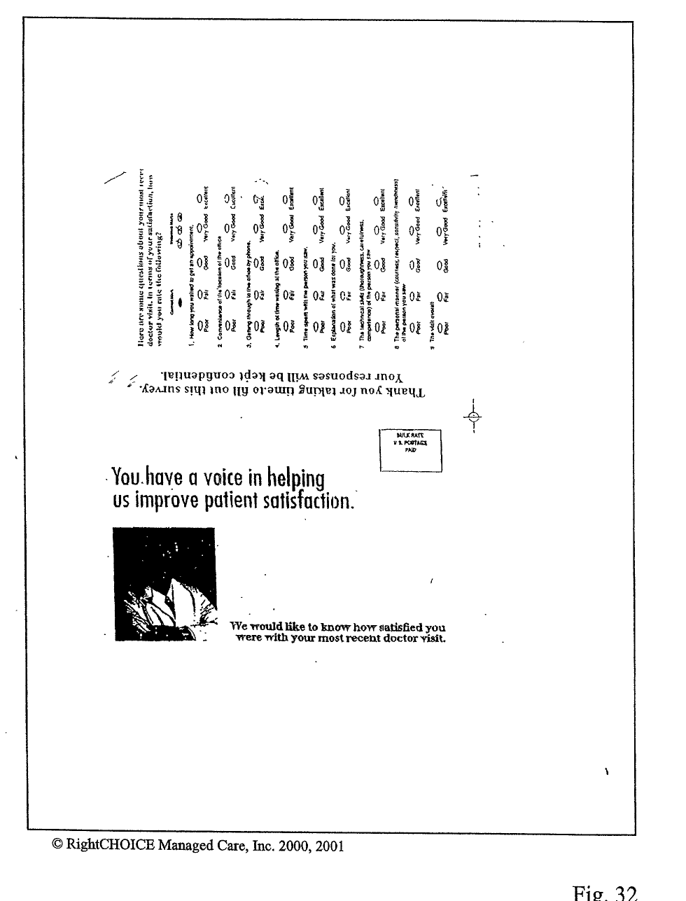

The quality measures preferably also includes some measure of patient satisfaction. One measure of patient satisfaction could be the American Association of Health Plan's nationally used 9 question survey. This survey was developed in 1988, and employs a five point scale (rankings from poor to excellent) to measure office visit related factors and physician competence perception. See FIG. 32.

Recently, the nationally weighted mean is 86%. A “pass” threshold using this survey might be at 80%. A valid sample size is determined to have a 95% confidence level. A survey will be considered valid if at least seven of the nine questions are completed. All nine questions are weighted equally. Of course, some other means of measuring patient satisfaction can be used.

The quality measures and the patient satisfaction measure are preferably blended (for example by weighted averaging) into an overall quality measure, and more preferably the quality measures are given greater weight than the patient satisfaction measures. For example, the quality measures could be weighted about 60% and the patient satisfaction measures could be weighted about 40%, or the quality measures could be weighted about 67% and the patient satisfaction measures could be weighted 33%.

A Level I quality goal can be defined as being within one standard deviation of the network mean score, or the network mean score for the particular specialty. A Level II quality goal can be defined as being better than a two standard deviation positive variance from the network mean score, or the network mean score for the particular specialty. A third intermediate level can be defined between Level I and Level II as being better than a one standard deviation positive variance, but less than a two standard deviation positive variance from the network mean score, or the net work mean score for the specialty. The reference to positive variance from the mean takes into account that for some quality measures a low score is better than a high score, and for other quality measures a high score is better than a low score, and to achieve Level II and Intermediate levels the score must be better, not simply arithmetically greater.

At the end of the contract year the actual cost performance is compared to the budgeted cost performance. The budget is adjusted upwardly or downwardly to account for changes in the actual mix of cases, e.g., increases and decreases in the severity of the illnesses of the patients seen. A casemix factor is determined by summing the Relative Value Units (RVUs) for each full or partial PTE, and dividing this sum by the total number of full and partial PTE's or PTE equivalents. The RVU is a measure of case complexity based upon resource consumption, comparable to the resource-based relative value scale (RBRVS) used in the Medicare program. The RVU assigns a relative value to all diagnostic clusters for each level of severity of illness, and facilitates comparison of expected resource usage across different severity of illness levels, and may also account for different ages/genders. Any system of assigning relative values to PTE's caused by different diseases and conditions, that takes into account the different resources employed, can be used. The Casemix factor is calculated for both the budget year and the actual performance year and the Adjustment_{casemix} is the Casemix_{performance year} divided by the Casemix_{budget year}. The TACClessRx for the budget year (TACClessRx_{budget year}) is then adjusted to allow a comparison that takes into account the severity of the illnesses treated each year. This is illustrated in Example 3.

### EXAMPLE 3

According to the budget developed at the start of the program year, a group was predicted to have a total of 3,472 full and partial PTE's (PTE equivalents), a Casemix_{budget year} of 1.2822, and a TACClessRx_{budget year}, of $981.91, while the actual performance resulted in 3,588 full and partial PTE's, a Casemix_{performance year} of 1.2803, and a TACClessRx_{performance year} of $1074.17. The Adjustment_{casemix} is Casemix_{performance year}/Casemix_{budget year} 1.2803/1.2822=0.9985. The Adjusted TACClessRx_{budget year} is therefore TACClessRx_{budget year} multiplied by the Adjustment Casemix=(0.9985)($981.91)=$980.48.

By dealing with the Total Average Covered Charge or TACClessRx, the program automatically adjusts for changes in the number of PTE's from the budget year and the performance year. The cost budget is preferably also adjusted for inflation/deflation. This can be done in any number of ways including through consumer price index, actual cost increase/decrease, etc. The adjusted budget cost is then compared to the actual costs, and if there is a net cost savings the group will be entitled to share in the savings provided that the group also met at a minimum Level I quality standards. If the actual performance of a group is below its budget, after that budget is adjusted for changes in case severity and inflation, and the group achieves at least the Level I quality goal, then the group is entitled to share in the cost saving, if any. The share is determined by two factors: whether the group is above or below the network's mean TACClessRx, and the measure of quality (Level I, Level II, or intermediate).

In comparing the group's TACClessRx with the network TACClessRx, it is desirable to adjust the network TACClessRx to the groups actual case mix. This can be accomplished according to the following formula: Adjusted Network TACClessRx=((Group Casemix)/(Network Casmix)) (Network TACClessRx).

In one example, being below budget but above the network mean TACClessRx entitles the group to a 35% share in the cost savings and being below budget and below the Adjusted Network mean TACClessRx entitles the group to a 45% share in the cost savings. Meeting Level I quality goal entitles the group to an additional 9% share, meeting Level II quality goal entitles the group to an additional 15% share, and achieving greater than Level I but less that Level II entitles the group to an additional 12% share. In reality, since at least Level I quality goals must be met to qualify for savings sharing, the minimum share is 44% (35% plus 9%). Table 5 shows the cost savings shares:

| | Group's | Group's |
|---|---|---|
| | TACClessRx higher | TACClessRx lower |
| | than Adjusted | than Adjusted |
| | Network mean | Network mean |
| | TACClessRx | TACClessRx |
| Achieve Level I quality goal | 44% | 54% |
| | (35% + 9%) | (45% + 12%) |
| Achieve greater than Level I | 47% | 57% |
| quality goal but less than | (35% + 12%) | (45% + 12%) |
| Level II quality goal | | |
| Achieve Level II quality goal | 50% | 60% |
| | (35% + 15%) | (45% + 15%) |

### EXAMPLE 4

A physicians group had a budget of 2,330 PTE's and a Casemix_{budget year} of 1.154, and a total average covered charge TACClessRx_{budget year} of $1350. The physicians group had an actual performance of 2,250 PTE's, a Casemix_{performance year} of 1.371, and a total average covered charge TACClessRx_{performance year} of $1,440. The casemix-adjusted TACClessRx_{budget} is $1604. Thus, although the actual TACClessRx_{performance year} was higher than TACClessRx_{budget year}, the adjusted TACClessRX_{budget year} was higher than the TACClessRx_{performance year}, so that there was an actual savings of $164. This means that there is a total savings of 2250 PTE's x $164/PTE=$369,000. If the group's TACClessRx_{performance year} of $1440 is below the network mean, and the group met Level I quality targets, the group is entitled to performance-based additional compensation of 54% (45%+9%) of the $369,000 savings or $199,260.

Reporting is an important part of the program to enable the groups, and the individual physicians in the groups to adjust their practices to provide appropriate patient care. Samples of some of the reports that provide useful feed back to the groups, the individual physicians, and the plan administrators are:

The Program Specialist Group PTE Profile with Network Comparison. This report, a sample of which is shwon in FIG. 3, ranks PTE Descriptions comparing the group against the network, showing PTE equivalents, casemix, TACC, and TACClessRx. This report provides the group with a comparison to the applicable specialty network including, whether the network experience is similar to the group's highest number of PTE's, the group's casemix vs. the network's casemix, and the group's TACC-Rx versus the network's TACC-Rx. This information helps the group to know the PTE's on which to focus.

Program Specialist Physician PTE Cost Categories Report. This report, a sample of which is shown in FIG. 5, compares, for the top three PTE descriptions, the physician's costs to both the group and network totals, per PTE description. The report shows TACC broken out as professional, Facility other and drug charges with further break outs within the first three subcategories for the period. This report allows comparison by individual physicians for a specified PTE, to the group and to the network for a breakdown of charge within specific categories.

PTE Detail Utilization—Inpatient report. This report, a sample of which is shown in FIG. 6, lists physicians for the top ten PTE descriptions, comparing the group against the network, The report shows PTE equivalents, casemix, TACC and breaks out TACC as professional, facility, other, and outpatient drug charges for the period. The report also shows inpatient admits per PTE equivalent and average coverage charge per admit for the period. For specific PTES (identified for focus because of high volume/cost), a listing of the physicians who treated members having these episodes comparing volume of PTE's, casemix, TACC-Rx and key utilization numbers to the network. This report allows for comparison to other physicians in the group, and is a good indicator for the individual PTE of variances or similarities in practice patterns for treating the specific type of episode.

The PTE Detail Utilization—Outpatient report. This report, a sample of which is shown in FIG. 7, lists physicians by PTE descriptions, comparing the group against the network. The report shows PTE equivalents, casemix, TACC and breaks out TACC as professional, facility, other, and outpatient drug charges for the period. The report also shows outpatient average number of visits, test services, and medical/surgical services for PTE equivalents for the period. For specific PTES (identified for focus because of high volume/cost), a listing of the physicians who treated members having these episodes comparing volume of PTE's, casemix, TACC-Rx and key utilization numbers to the network. This report allows for comparison to other physicians in the group, and is a good indicator for the individual PTE of variances or similarities in practice patterns for treating the specific type of episode.

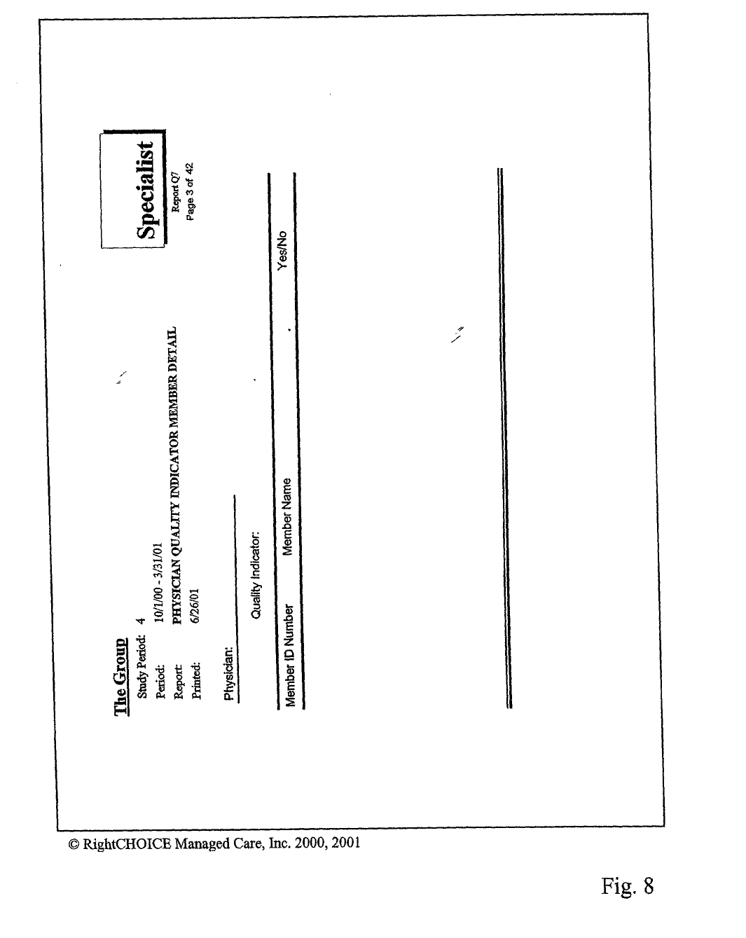

The Physician Quality Indicator Member Detail report. This report, a sample of which is shown in FIG. 8, lists members by physician per quality indicator. The report shows whether the member received service or not. This report provides individual and group physicians with a listing of members who qualify for the quality indicator. The report also shows the members who did not receive service. This allows the physician to check the information for accuracy.

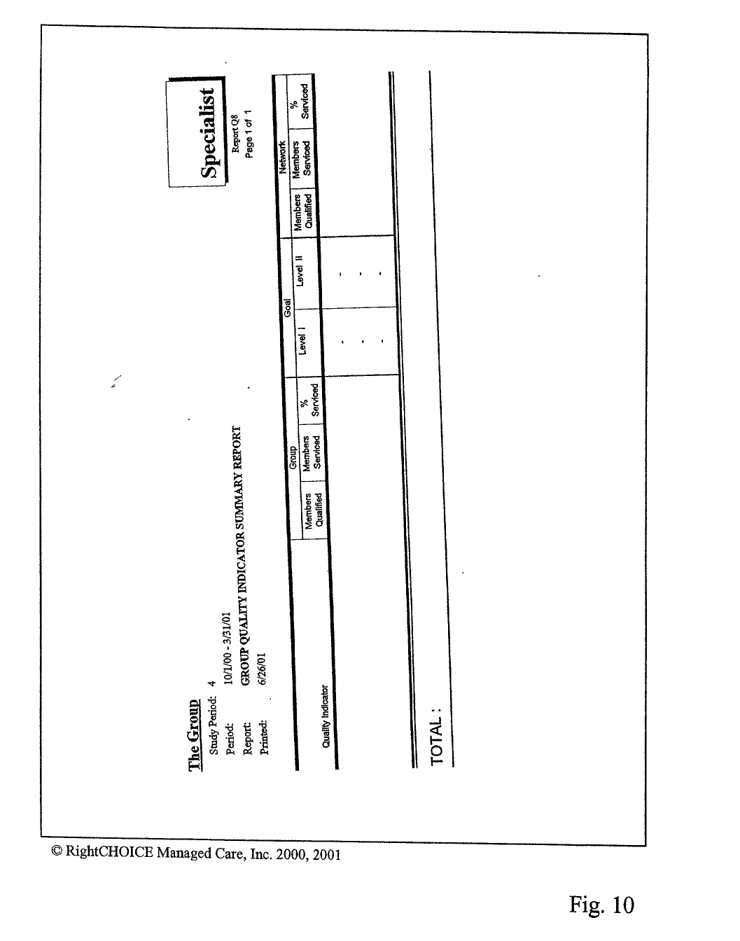

The Group Quality Indicator Summary report. This report, a sample of which is shown in FIG. 10, lists member counts by quality indicator for the group and network. This report shows the count of members who qualified and the count of members who received service for the group and network. The report provides a summary of the status of the quality indicators, and allows groups to see, for each quality indicator, the group's current level of compliance with the goal levels and comparison with the network.

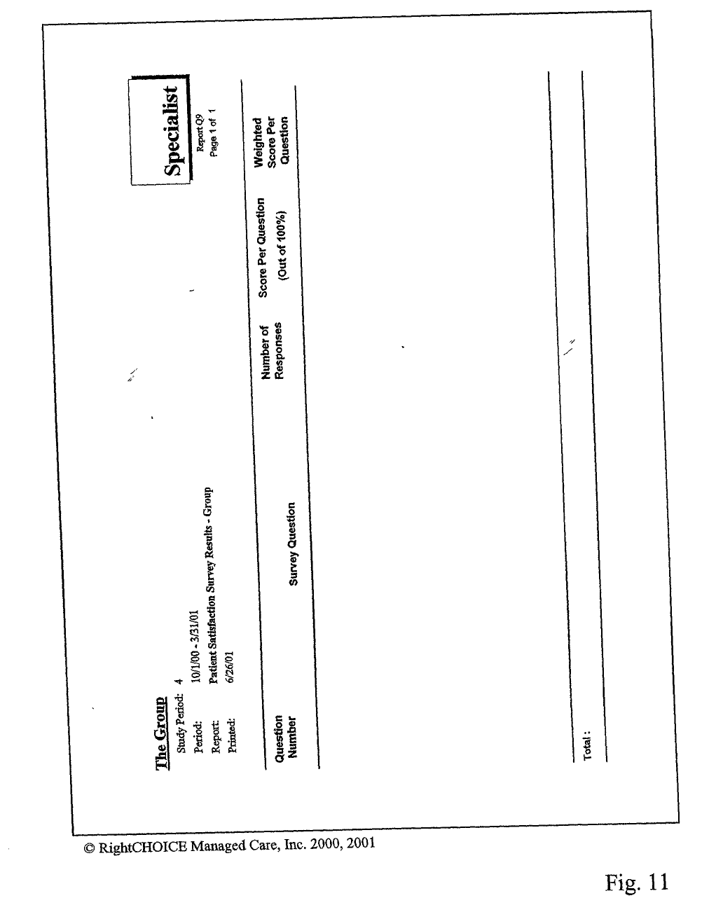

The Patient Satisfaction Survey Results—Group report. This report, a sample of which is shown in FIG. 11, lists for the group, the survey responses from members for each evaluation survey question. It shows the response percent and the weighted percent. The report provides feedback from the members serviced by the provider group.

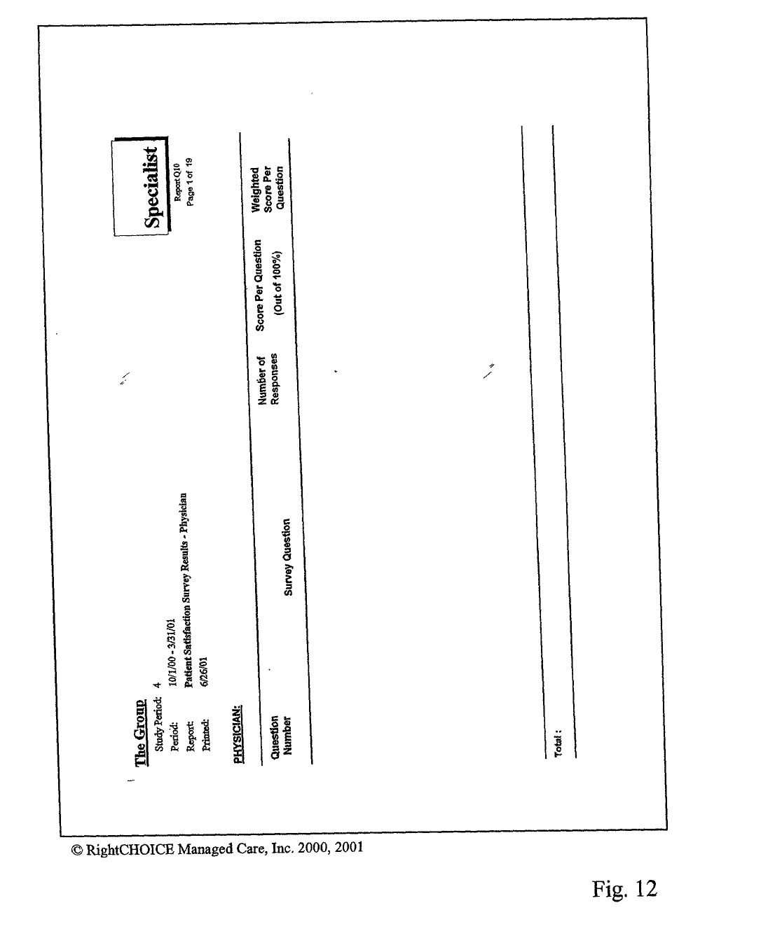

The Patient Satisfaction Survey Results—Physician report. This report, a sample of which is shown in FIG. 12, lists for each physician in the group, the evaluation survey responses from members for each survey question. The report shows the response percent and the weighted response. This report provides feedback from the members served by the provider group.

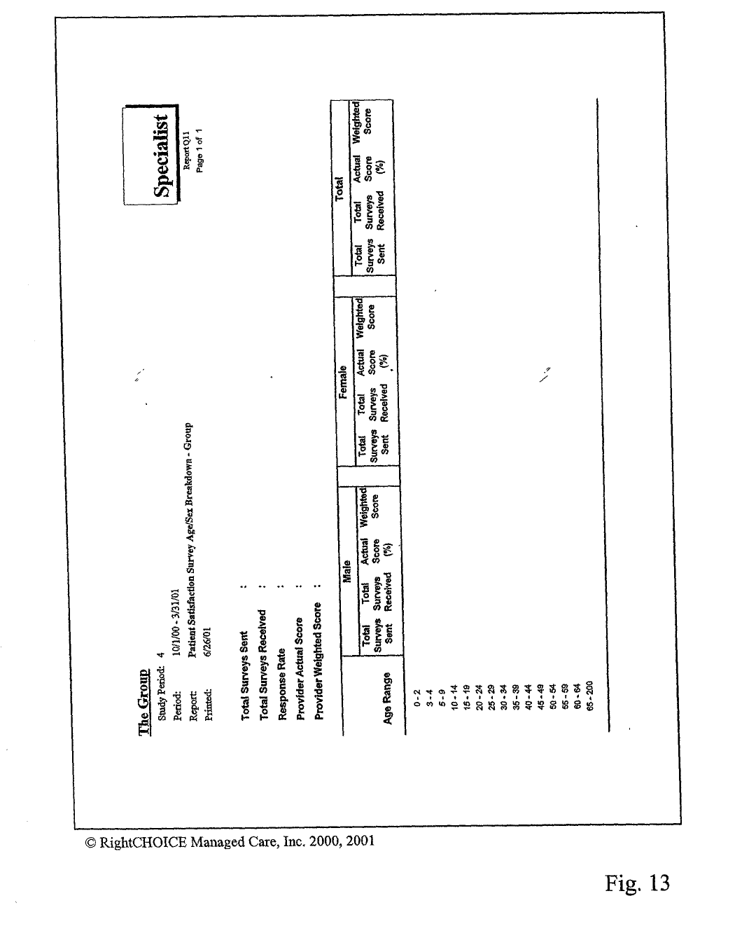

The Patient Satisfaction Survey Age/Sex Breakdown—Group report. This report, a sample of which is shown in FIG. 13, lists for the group, the number of surveys sent to members and the number of surveys received back from members. It also breaks out the number of the surveys sent and surveys received by age range and gender. This report provides feedback from the members served by the provider group.

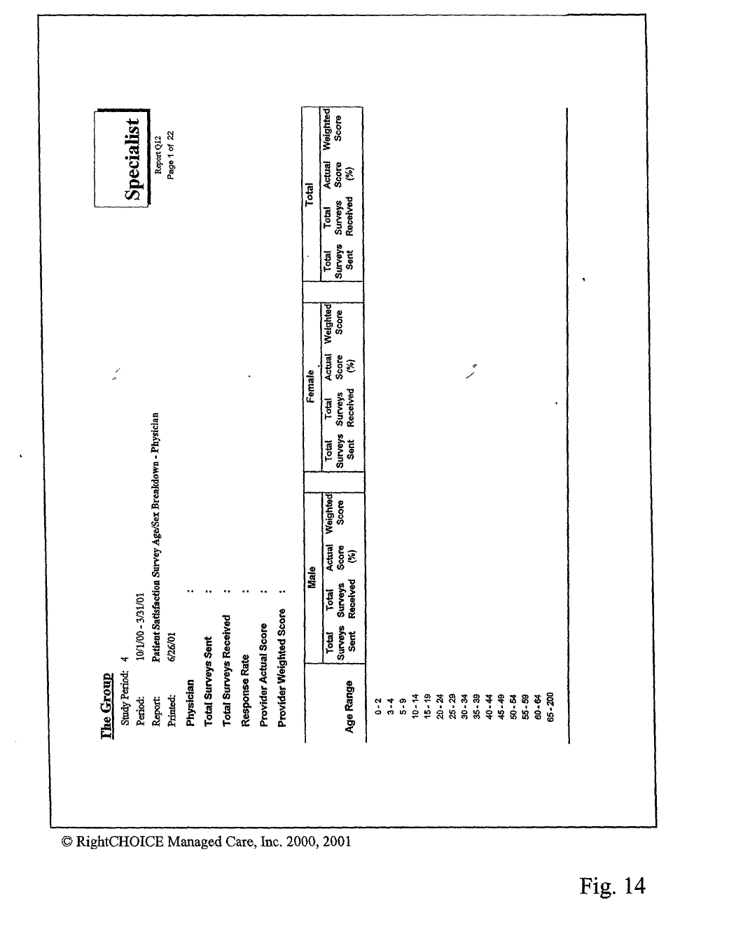

The Patient Satisfaction Survey Age/Sex Breakdown—Physician. This report, a sample of which is shown in FIG. 14, lists for each physician in the group, the number of surveys sent to members and the number of surveys received back from members. It also breaks out the number of the surveys sent and surveys received by age range and gender. This report provides feedback from the members served by the provider group.

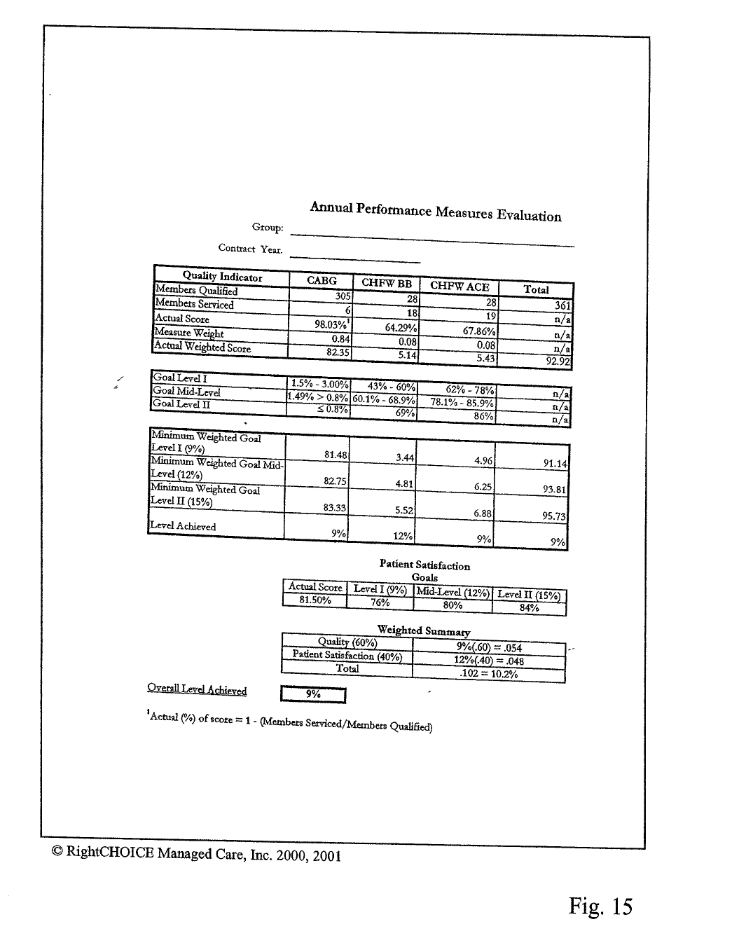

The Annual Performance Measures report. This report, a sample of which is show in FIG. 15, summarizes the group's actual results on the performance measures for the contract year. This allows evaluation the group's performance in relation to the established goals and calculates the overall level achieved by the group on the performance measures.

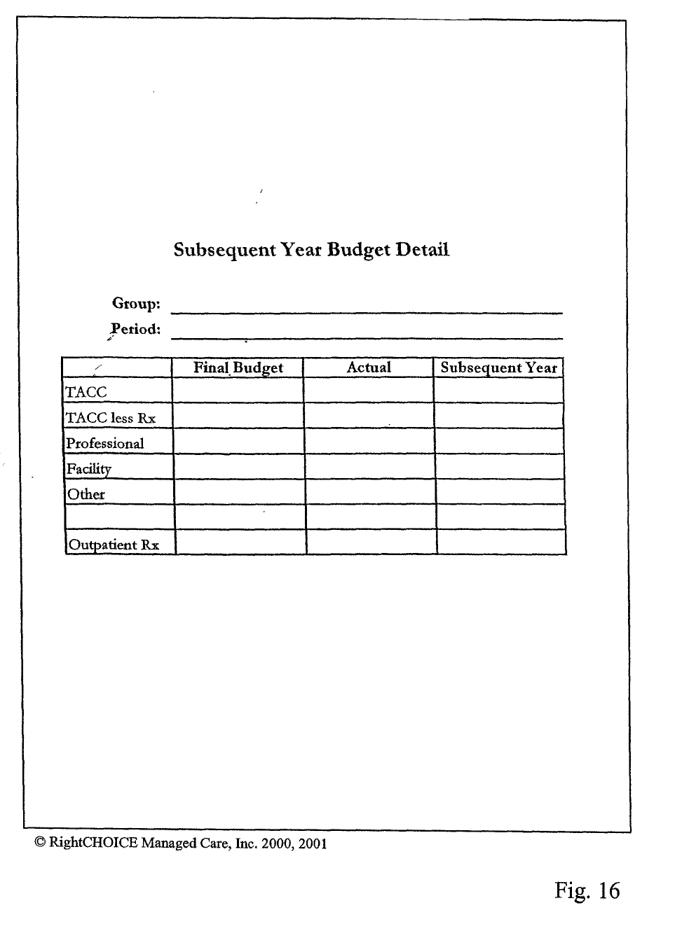

The Subsequent Year Budget report. The report, a sample of which is shown in FIG. 16, calculates for the group the final unadjusted budget for the next contract year based on the results of the most recent reconciliation.

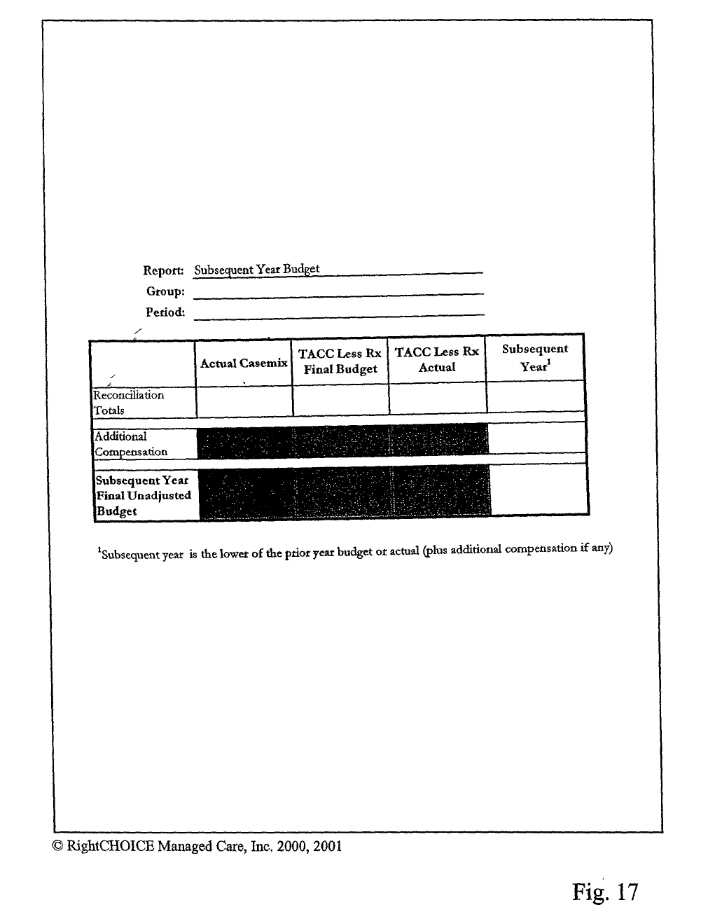

The Subsequent Year Budget Detail report. This report, a sample of which is shown in FIG. 17, provides detail by major cost category of the group's final unadjusted budget for the next contract year. The cost category detail is used for interim reporting.

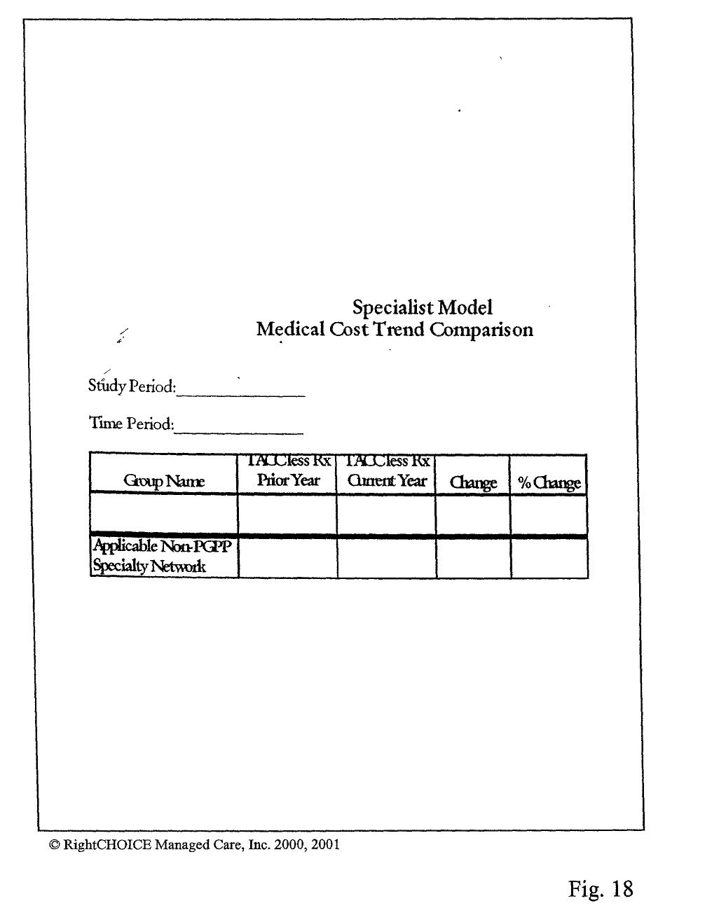

The Medical Cost Trend Comparison report. This report, a sample of which is shown in FIG. 18, compares the rate of change for a Program group, from the prior to the current year, to the non-PGPP applicable medical specialty network change for the same time period.

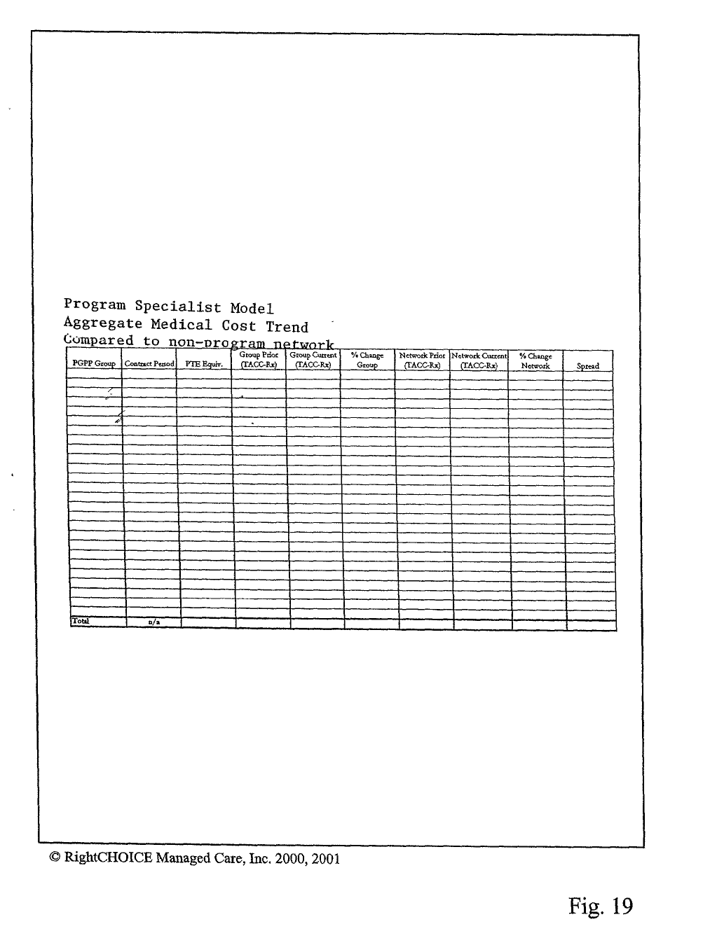

The Program Specialist Aggregate Medical Cost Trend Compared to Non-Network report. This report, a sample of which is shown in FIG. 19, aggregates, for all reconciled Program groups, the medical cost trend comparison results to determine an overall comparison of Program to the non-Program applicable medical specialty network.

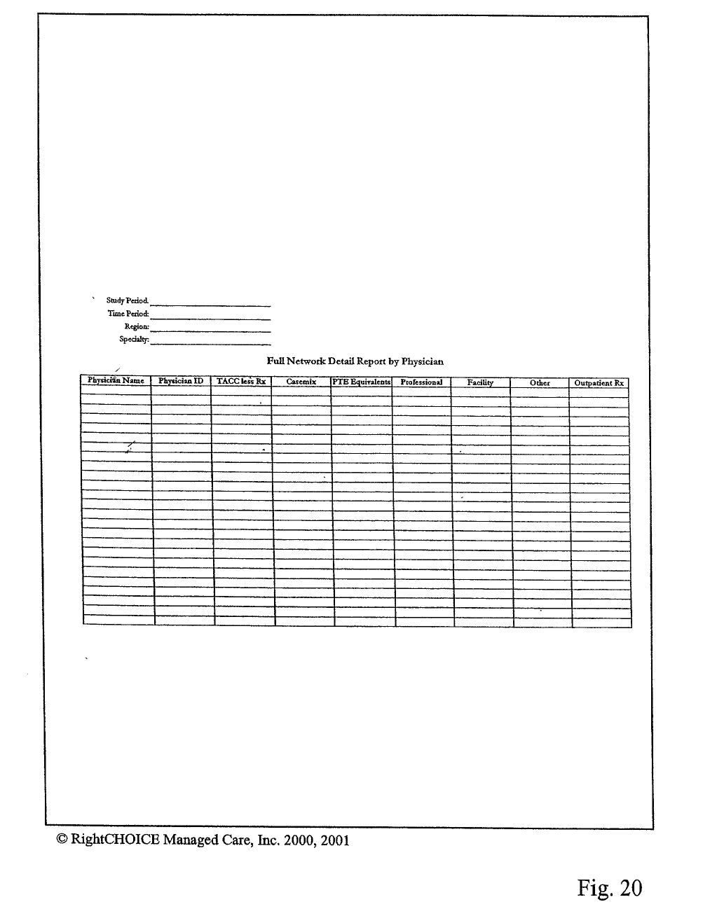

The Full Network Detail Report by Physician. This report, a sample of which is shown in FIG. 20, provides the detail necessary to create a sales budget for a prospective physician group and a final unadjusted budget for the first year of a PGPP group.

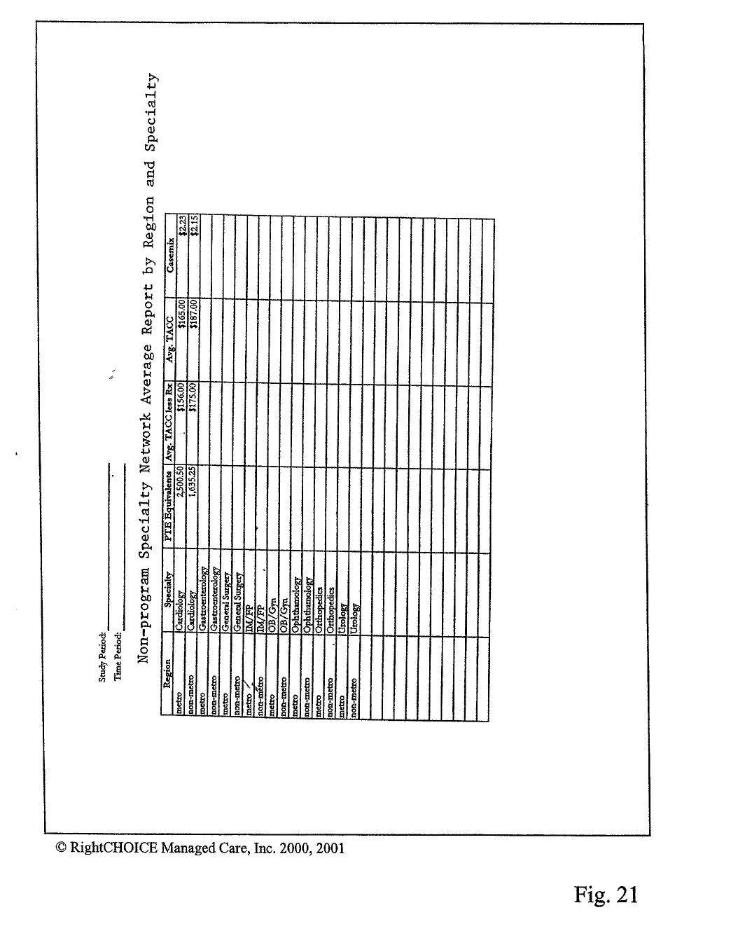

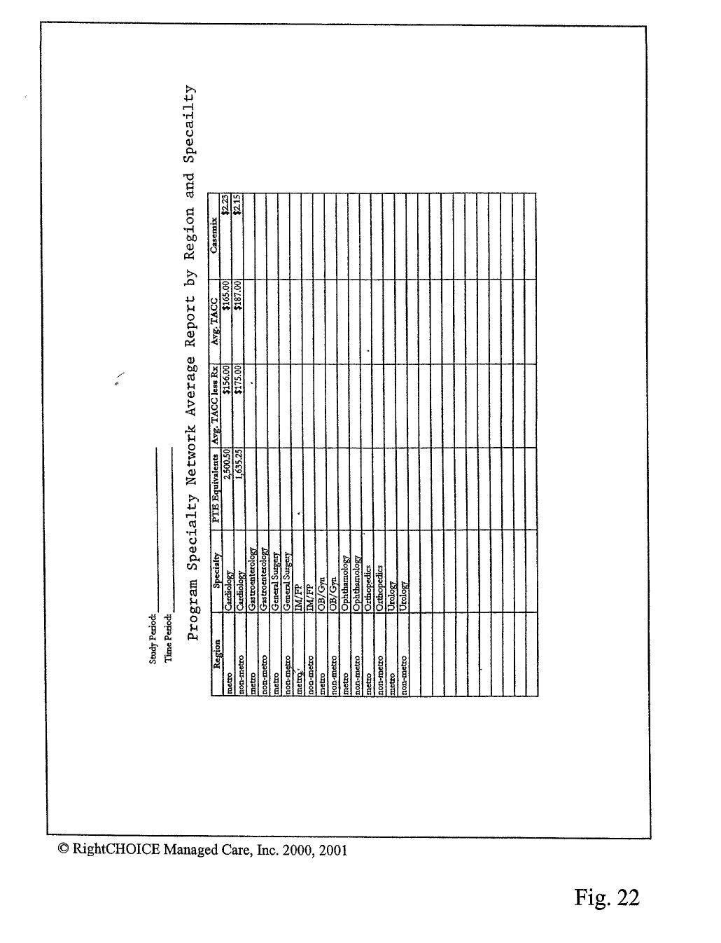

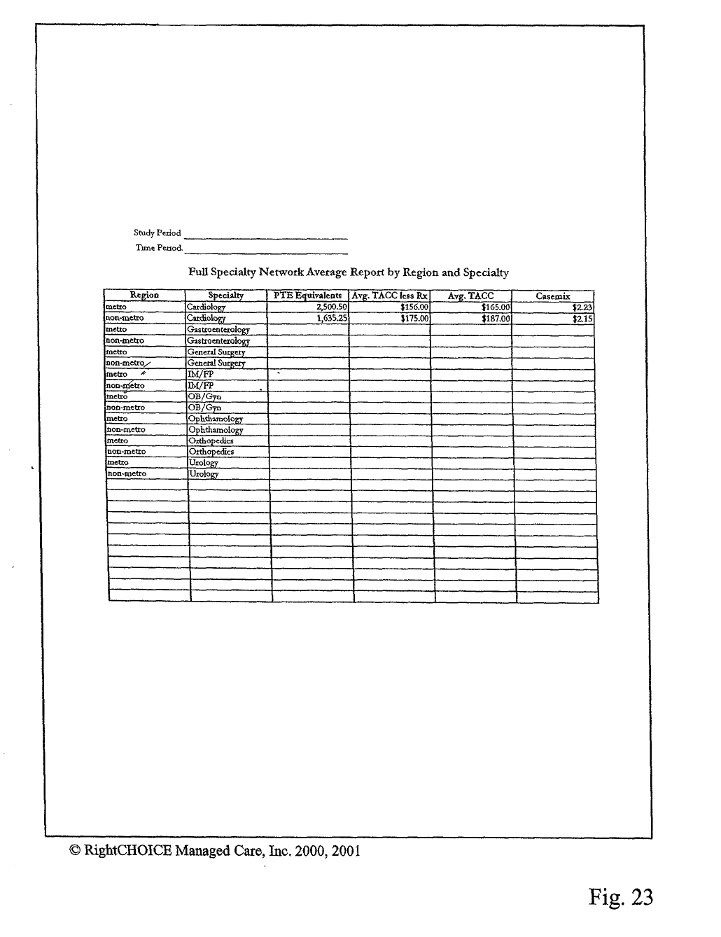

The Non-Specialty Network Average Report by Region and Specialty. The Program Specialty Network Average Report by Region and Specialty. The Full Specialty Network Average Report by Region and Specialty. These reports, samples of which are shown in FIGS. 21, 22 and 23, provide the average TACCless Rx for the applicable medical specialty network that allows for calculation of the percentage of gainshare achieved by the group. The three reports provide the ability to look at this data either with the entire network or broken out by Program and non-Program physicians.

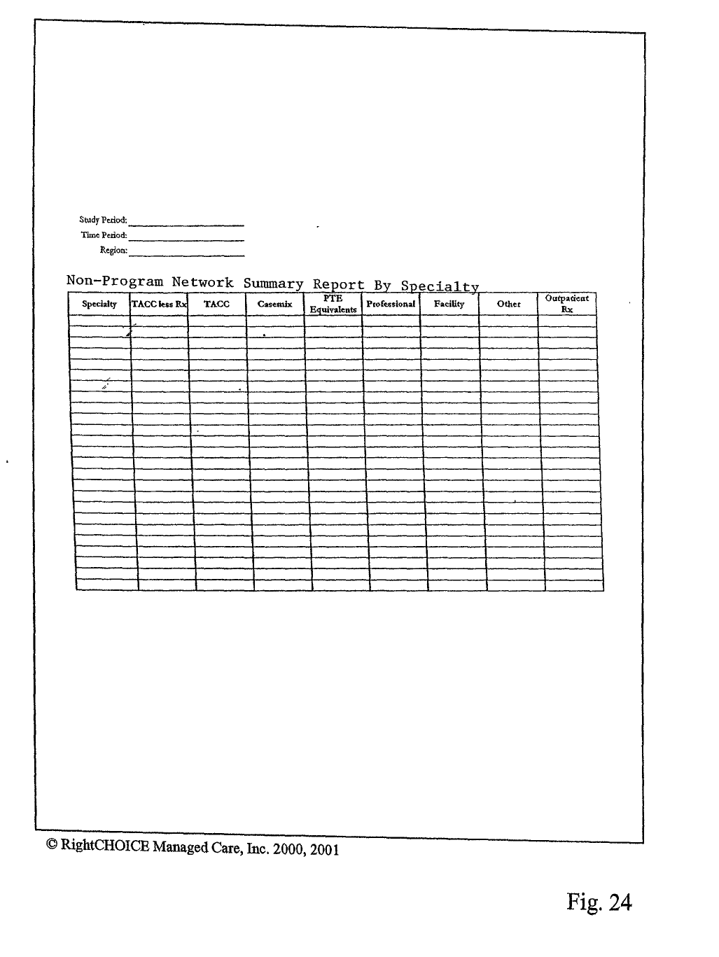

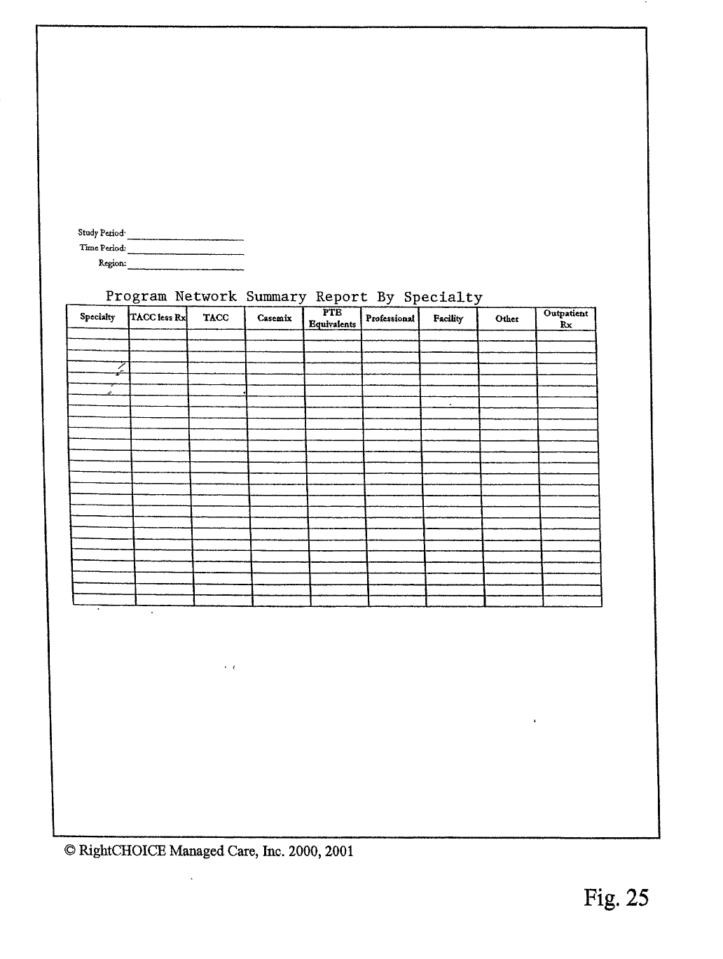

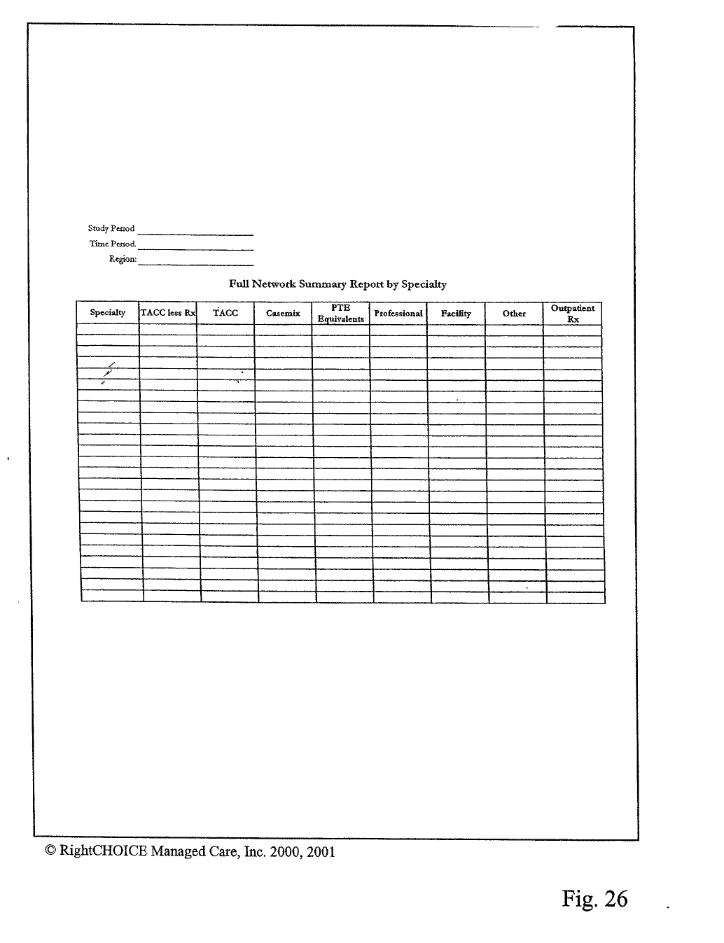

The Program Non-Network Summary Report by Specialty. The Network Summary Report by Specialty. The Full Network Summary Report by Specialty. These reports, samples of which is shown in FIGS. 24, 25 and 26, provide the ability to compare the PGPP groups to the appropriate network for comparison of medical cost trend differences.

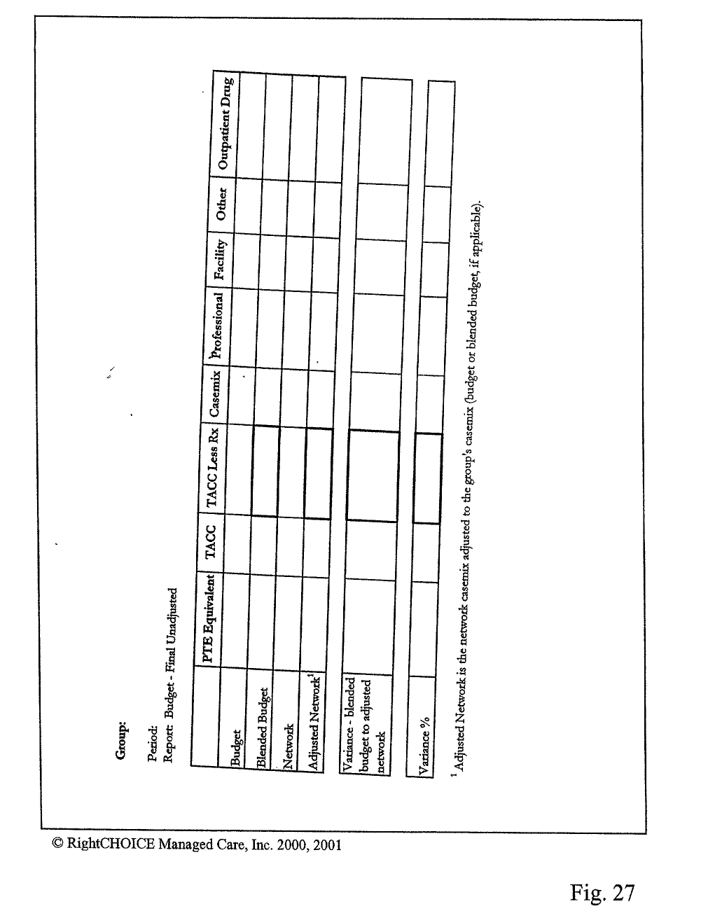

The Budget Final Unadjusted Report. This report, a sample of which is shown in FIG. 27, compares the group against the network for PTE equivalents, casemix, TACC, TACClessRx and breaks out TACClessRx as professional, facility, other and outpatient drug charges. This report establishes the final unadjusted budget for a physician group. It also provides the PTE equivalents to determine the percent of the groups prior twelve-month history to use. It further provides the group's and the network's casemix, which allows for adjustment of the network's TACC-Rx. Finally it provides comparison of the group to network and breaks out TACC-Rx into major categories to identify for the group broad areas of focus.

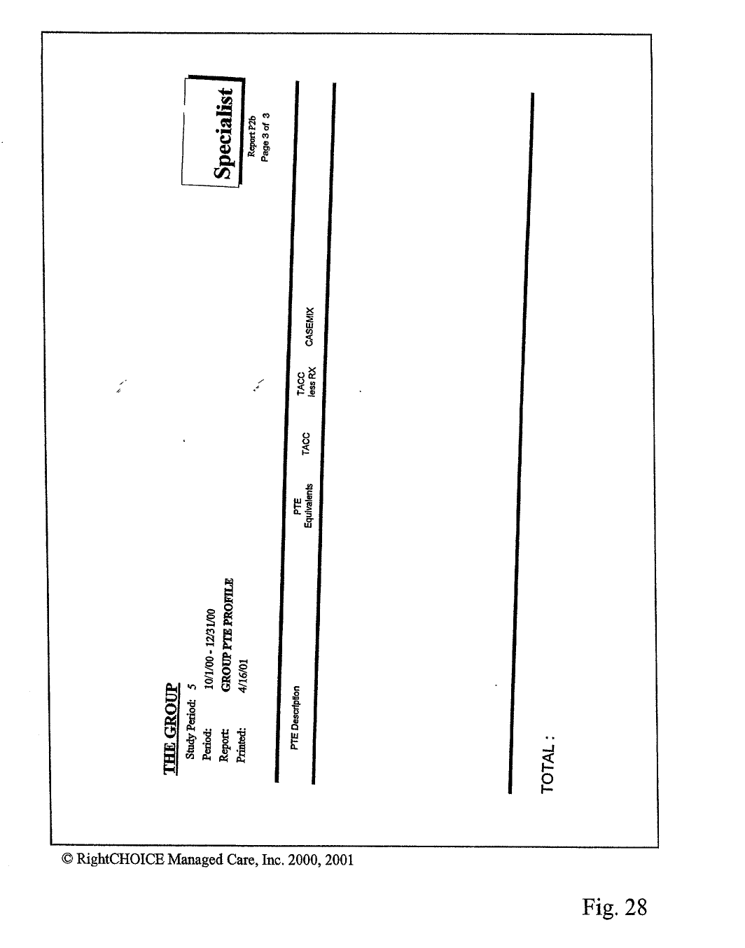

The Group PTE Profile Report. This report, a sample of which is shown in FIG. 28, ranks PTE description by PTE equivalents and shows PTE equivalents, casemix, TACC and TACClessRx. This report provides the group with a listing of the PTE'S treated by the group, ranked from highest to lowest PTE equivalent. This allows the group to know the PTE's with the most potential for financial impact. The Group PTE Profile with comparison to specialty network is a companion report allowing for companion to the applicable specialty network, which provides more guidance on the areas on which to focus.

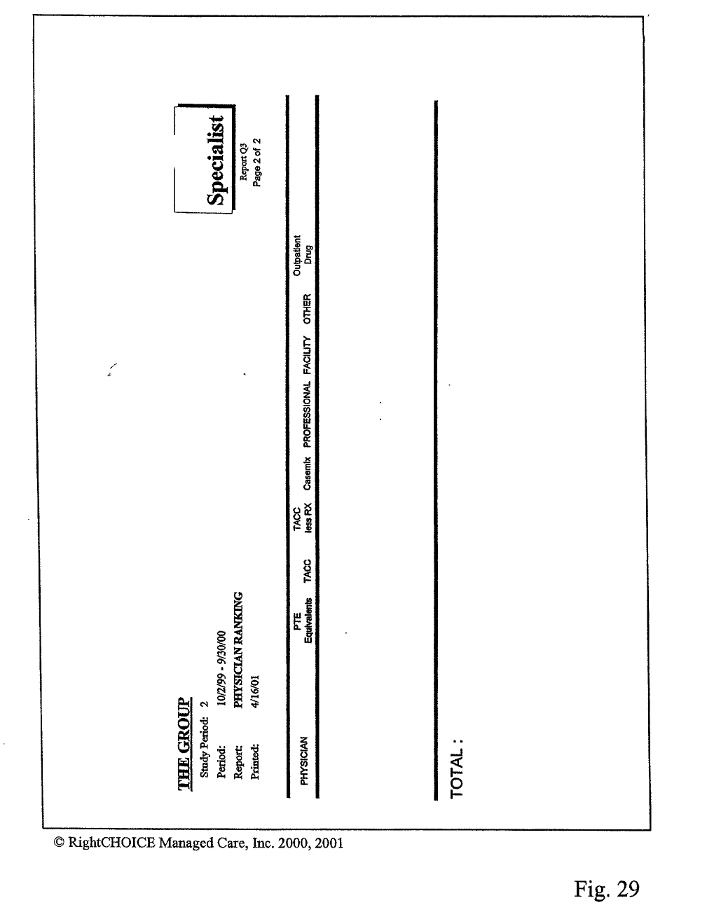

The PGPP Specialist Physician Ranking Report. This report, a sample of which is shown in FIG. 29, ranks physicians by PTE equivalents and shows: PTE equivalents, casemix, TACC, TACClessRx and breaks out TACC as the professional, facility, other and outpatient drug charges for the period. This report provides the group with a listing of physicians in the group ranked from highest to lowest PTE equivalents. It shows the TACC-Rx and casemix for each physician. This allows for comparison of the physicians within the group, and broad categories for physician to physician comparison.

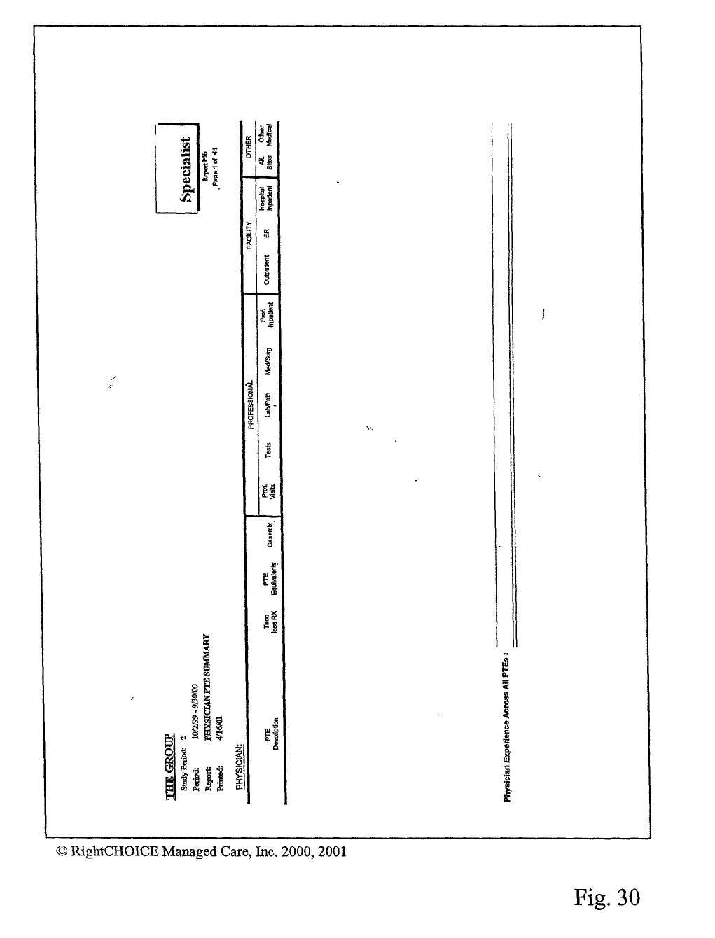

The Specialist Physician PTE Summary Report. This report, a sample of which is shown in FIG. 30, ranks PTE description within each physician by PTE equivalents and shows: PTE equivalents, casemix, TACClessRx, and breaks out TACClessRx as professional, facility, and other charges with further breakout within these three subcategories. This report by physician identifies all PTE's assigned to the physician ranked from highest to lowest PTE equivalent. This allows the physician and the group to know which PTE's to change for greatest impact. The report breaks out for each PTE specific categories of cost making up the TACClessRx so the physician can focus more specifically.

The method of implementing by contracting with groups of physicians, and a copy of a sample contract is attached as Appendix A and incorporated by reference.

Thus the method of this invention incentivizes physician groups as the health services experts to make the most appropriate care decisions for patients. The method provides increased autonomy for physicians, and the potential for increased compensation. The method encourages physicians to work as a group, and to share information to raise the level of performance and practices. The method also rewards physicians with performance based additional compensation.

[image]

[image]

[image]

[image]

[image]

[image]

[image]

What is claimed is:

1. A method of compensating a health service provider providing health services in service episodes to health plan members, the method comprising sharing a portion of the cost savings resulting from the provider's reduction of actual average cost per service episode compared to a predetermined budgeted average cost per service episode, the portion depending in part upon the provider's average cost per service episode compared to an average cost per service episode of providers to the members, and in part upon the provider's performance on at least one of a quality measure and a member satisfaction measure.

2. The method according to claim 1 wherein the provider's actual average cost per service episode and the budgeted average cost per service episode are indexed to the same level of episode severity before comparison.

3. The method according to claim 1 wherein the provider's actual average cost per service episode and the average cost per service episode of care of providers to the members of the health plan are indexed to the same level of episode severity before comparison.

4. The method according to claim 1 wherein the portion of the cost savings shared with the provider depends upon whether the provider's average cost per service episode is above or below the median average cost per service episode of care of providers to the members of the health plan.

5. The method according to claim 1 wherein the portion of the cost savings shared with the provider depends in part upon the provider's performance on a quality measure.

6. The method according to claim 1 wherein the portion of the cost savings shared with the provider depends in part upon the provider's performance on a member satisfaction measure.

7. The method according to claim 1 wherein the portion of the cost savings shared with the provider depends in part upon the provider's performance on a measure of quality measure and member satisfaction.

8. The method according to claim 1 wherein the service provider is a group of individuals.

9. The method according to claim 1 wherein the service provider is a group of individuals in a particular medical specialty, and wherein the comparison between the provider's average cost per service episode and an average cost per service episode of care of providers providing service to the members of the health plan is made with providers in the same medical specialty.

10. A method of compensating a group of physicians providing health services in service episodes to health plan members, the method comprising sharing a portion of the cost savings resulting from the reduction of the group's actual average cost per service episode compared to a predetermined budgeted average cost per service episode, the portion depending in part upon the group's average cost per service episode compared to an average cost per service episode of groups providing service to the members, and in part upon the group's performance on at least one of a quality measure and a member satisfaction measure.

11. The method according to claim 10 wherein the group's actual average cost per service episode and the group's budgeted average cost per service episode are indexed to the same level of episode severity before comparison.

12. The method according to claim 10 wherein the group's actual average cost per service episode and the average cost per service episode of care of the group's serving the health plan members are indexed to the same level of episode severity before comparison.

13. The method according to claim 10 wherein the portion of the cost savings shared with the group depends upon whether the group's average cost per service episode is above or below the mean of the average cost per service episode of care of groups providing the same type of health service to the members of the health plan.

14. The method according to claim 10 wherein the portion of the cost savings shared with the group depends in part upon the group's performance on a quality measure.

15. The method according to claim 10 wherein the portion of the cost savings shared with the provider depends in part upon the group's performance on a member satisfaction measure.

16. The method according to claim 10 wherein the portion of the cost savings shared with the provider depends in part upon the group's performance on a quality measure and a member satisfaction measure.

17. The method according to claim 10 wherein the group is a group of individuals in a particular medical specialty, and wherein the comparison between the group's average cost per service episode and the average cost per service episode of care of groups providing service to the members of the health plan is made only with groups in the same medical specialty.

18. A method of compensating physicians for managing the cost and quality of health care services provided to members of a health plan served by a plurality of physician groups, the method comprising:
developing a budgeted cost per episode of patient for a program period for at least one physician group based at least in part on the historic actual performance of the group;
compiling data on actual cost per episode of patient care during the program period;
comparing the group's actual cost per episode of patient care during the program period with the group's budgeted cost per episode of patient care for the program period, adjusted for changes in the severity of illness of the patients treated;
sharing a portion of the savings resulting from a reduction in actual cost per episode of patient care with the group, the portion depending upon the group's performance on a quality and/or patient satisfaction indicator.

19. The method according to claim 18 wherein the sharing of a portion of the savings is also dependent on the group's performance relative to other physicians.

20. The method according to claim 19 wherein the sharing of a portion of the savings of a group is dependant on a comparison of a measure of the group's cost per episode of patient care with a measure of other physicians' cost per episode of patient care.

21. The method according to claim 20 wherein the measure of the group's cost per episode of patient care and the measure of other physicians' cost per episode of patient care in indexed to the same level of episode severity before comparison.

22. The method according to claim 18 wherein the portion of savings shared with the group depends upon the group's performance on a quality indicator relative to other physicians' performance on the quality indicator.

23. The method according to claim 18 wherein the quality indicator includes a measurement of the number of patients with a particular diagnosis receiving a particular treatment.

24. The method according to claim 18 wherein the quality indicator includes a measurement of the number of patients with a particular diagnosis not receiving a particular treatment.

25. The method according to claim 18 wherein the quality indicator includes a measurement based on survey responses of plan members treated by the group.

26. The method according to claim 18 wherein a group's budgeted cost per episode of patient care is determined based at least in part on the historic performance of the individual physicians in the group.

27. The method according to claim 26 wherein the weight given to the historic performance of an individual physician in the group depends upon that physician's total number of episodes of care.

28. The method according to claim 26 wherein the weight given to the historic performance of an individual physician in the group depends upon the physician's number of episodes of care and the physician's medical specialty.

29. The method according to claim 18 wherein the budgeted cost per episode of patient care and the actual cost per episode of patient care exclude outpatient prescription pharmaceuticals.

30. The method according to claim 18 wherein the comparison between group's actual cost per episode of patient care during the program period with the group's budgeted cost per episode of patient care for the program period, is adjusted to take into account inflation between the time of the budget and the program period.

31. The method according to claim 30 wherein the adjustment to take into account inflation is implemented by increasing the group's budgeted cost per episode of patient care.

32. The method according to claim 30 wherein the adjustment to take into account inflation is implemented by decreasing the group's actual cost per episode of patient care.

33. The method according to claim 18 wherein the adjustment for changes in the severity of illness of the patients treated comprises indexing the relative costs of the episodes of care used in determining budgeted cost per episode of patient care, and the relative costs of the episodes of care used in determining the actual cost per episode of patient care.

34. A method managing the cost of heath services provided to members of a health plan served by a plurality of physician groups, by compensating physician groups for managing the cost and quality of health care services, the method comprising:
sharing with a group a portion of the cost savings resulting from that group's reduction in the cost episode of patient care during a period from a predetermined budgeted cost per episode of patient care for that period, the portion being determined at least in part by the group's performance on a quality and/or patient satisfaction indicator.

35. The method according to claim 34 wherein the portion is determined by the group's performance on a quality indicator relative to other physician's performance on that quality indicator.

36. The method according to claim 34 wherein the budgeted cost per episode of patient care is based at least in part upon the group's historical performance.

37. The method according to claim 36 wherein the weight give to a group's historical performance depends upon the number of years of data for the group.

38. The method according to claim 37 wherein the weight given to a group's historical performance depends upon the number of years of data for the group and the group's specialty.

39. The method according to claim 36 wherein the weight given to the historic performance of an individual physician in the group depends upon the physician's number of episodes of care and the physician's medical specialty.

40. The method according to claim 36 wherein the budgeted cost per episode of patient care is based in part on the historic performance of the individual physicians in the group.

41. The method according to claim 34 wherein the quality indicator includes a measurement of the number of patients with a particular diagnosis receiving a particular treatment.

42. The method according to claim 34 wherein the sharing of a portion of the savings is also dependent on the group's performance relative to other physicians

43. The method according to claim 42 wherein the sharing of a portion of the savings of a group is dependant on a comparison of a measure of the group's cost per episode of patient care with a measure of other physician's cost per episode of patient care.

44. The method according to claim 34 wherein the quality indicator includes a measurement of the number of patients with a particular diagnosis not receiving a particular treatment.

45. The method according to claim 34 wherein the quality indicator includes a measurement based on survey responses of plan members treated by the group.
